(19) United States
(12) Patent Application Publication
(10) Pub. No.: US 2019/0090189 A1
(43) Pub. Date: Mar. 21, 2019

(54) WAKE-UP MESSAGE GENERATION AND DECODING

(71) Applicant: QUALCOMM Incorporated, San Diego, CA (US)

(72) Inventors: Michael John STORY, Whittlesford (GB); Robin HEYDON, Cambridge (GB); Mayank BATRA, Cambridge (GB)

(21) Appl. No.: 15/712,007

(22) Filed: Sep. 21, 2017

(51) Int. Cl. H04W 52/02; H04W 68/02; H04W 72/04; H04L 5/00; H04W 76/04

(52) U.S. Cl. CPC H04W 52/0229; H04W 68/02; H04W 60/04; H04L 5/0094; H04W 76/048; H04W 72/042

(57) ABSTRACT

A method, an apparatus, and a computer-readable medium for wireless communication are provided. In one aspect, an example method may include generating, by a first device, a wake-up message, The method may include transmitting, by the first device, the wake-up message to a second device. Generating the wake-up message may include encoding an address associated with the second device into a plurality of packets. The length of each packet of the plurality of packets in combination may be representative of the address. At least two packets of the plurality of packets may vary in packet length by a multiple of a packet length variance value. The wake-up message may include the plurality of packets.

### BACKGROUND

### Field

The present disclosure relates generally to communication systems, and more particularly, to one or more techniques for signaling a wake-up message and/or waking up a main receiver by a wake-up receiver based on a received wake-up message.

### Background

In many wireless systems, communications networks are used to exchange messages among several interacting spatially-separated devices. Networks may be classified according to geographic scope, which may be, for example, a metropolitan area, a local area, or a personal area. Such networks may be designated respectively as a wide area network (WAN), metropolitan area network (MAN), local area network (LAN), wireless local area network (WLAN), or personal area network (PAN). Networks may also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

A wireless device may include a receiver. To conserve battery, the receiver of the wireless device may be configured to enter an active state and an inactive state according to a schedule. When inactive, the receiver may not significantly drain the battery of the wireless device. When active, the receiver may drain the battery of the wireless device. However, enabling or disabling a receiver based solely on a schedule may lead to: activation of the receiver when no data is present resulting in inefficient power consumption, over activation of the receiver resulting in inefficient power consumption, and/or under activation of the receiver resulting in not receiving data destined for the wireless device. Therefore, there remains a need to conserve the battery of a wireless device while providing more precise control of when a receiver of a wireless device wakes up (e.g., enters an active state from an inactive state).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be configured to receive, by a first receiver of the apparatus, a wake-up message. The wake-up message may include a plurality of packets. The apparatus may be configured to determine, by the first receiver, a respective packet length for each packet of the plurality of packets. Each respective packet may vary in packet length relative to at least one other respective packet of the plurality of packets by a respective multiple of a packet length variance value. The apparatus may be configured to generate, by the first receiver, a decoded address by being configured to convert each respective packet length of the plurality of packet lengths into a corresponding respective address value. Each respective address value in combination may be the decoded address. The apparatus may be configured to compare, by the first receiver, the decoded address to an address associated with the device. The apparatus may be configured to activate or not activate, by the first receiver, a second receiver of the apparatus based on the comparison. The first receiver may be configured to activate the second receiver when the decoded address matches the address associated with the apparatus. The first receiver may be configured to not activate the second receiver when the decoded address does not match the address associated with the device.

In another aspect of the disclosure, a method, a computer-readable medium, and an apparatus are provided. The apparatus may be configured to generate a wake-up message. The apparatus may be configured to transmit the wake-up message to a second apparatus. To generate the wake-up message, the apparatus may be configured to encode an address associated with the second apparatus into a plurality of packets. The length of each packet of the plurality of packets in combination may be representative of the address. At least two packets of the plurality of packets vary in packet length by a multiple of a packet length variance value. The wake-up message may include the plurality of packets.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 an example wireless communication system in in accordance with one or more techniques of this disclosure.

FIGS. 2A-B illustrate an example flow diagram between a primary device and a secondary device in accordance with one or more techniques of this disclosure.

FIG. 3A illustrates an example of a wake-up message in accordance with one or more techniques of this disclosure.

FIG. 3B illustrates an example of available packet lengths in accordance with one or more techniques of this disclosure.

FIG. 3C illustrates example envelopes respectively corresponding to each of the packets illustrated in FIG. 3B.

FIG. 4 illustrates a wake-up message with four packets of varying length that has been modulated in accordance with one or more techniques of this disclosure.

FIG. 5 illustrates one example of one or more criteria that a filter may be configured to check in accordance with one or more techniques of this disclosure.

FIG. 6 illustrates an example flowchart of a method in accordance with one or more techniques of this disclosure.

FIG. 7 illustrates an example flowchart of a method in accordance with one or more techniques of this disclosure.

FIG. 8 is a conceptual data flow diagram illustrating the data flow between different means/components in an exemplary apparatus in accordance with one or more techniques of this disclosure.

FIG. 9 is a diagram illustrating an example of a hardware implementation for an apparatus employing a processing system in accordance with one or more techniques of this disclosure.

FIG. 10 is a conceptual data flow diagram illustrating the data flow between different means/components in an exemplary apparatus in accordance with one or more techniques of this disclosure.

FIG. 11 is a diagram illustrating an example of a hardware implementation for an apparatus employing a processing system in accordance with one or more techniques of this disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, the techniques of this disclosure are directed to techniques for signaling a wake-up message and/or waking up a main receiver by a wake-up receiver based on a received wake-up message. In some examples, the techniques described herein may enable more efficient conservation of the battery of a device while providing more precise control of when a main receiver of a wireless device wakes up (e.g., enters an active state from an inactive state).

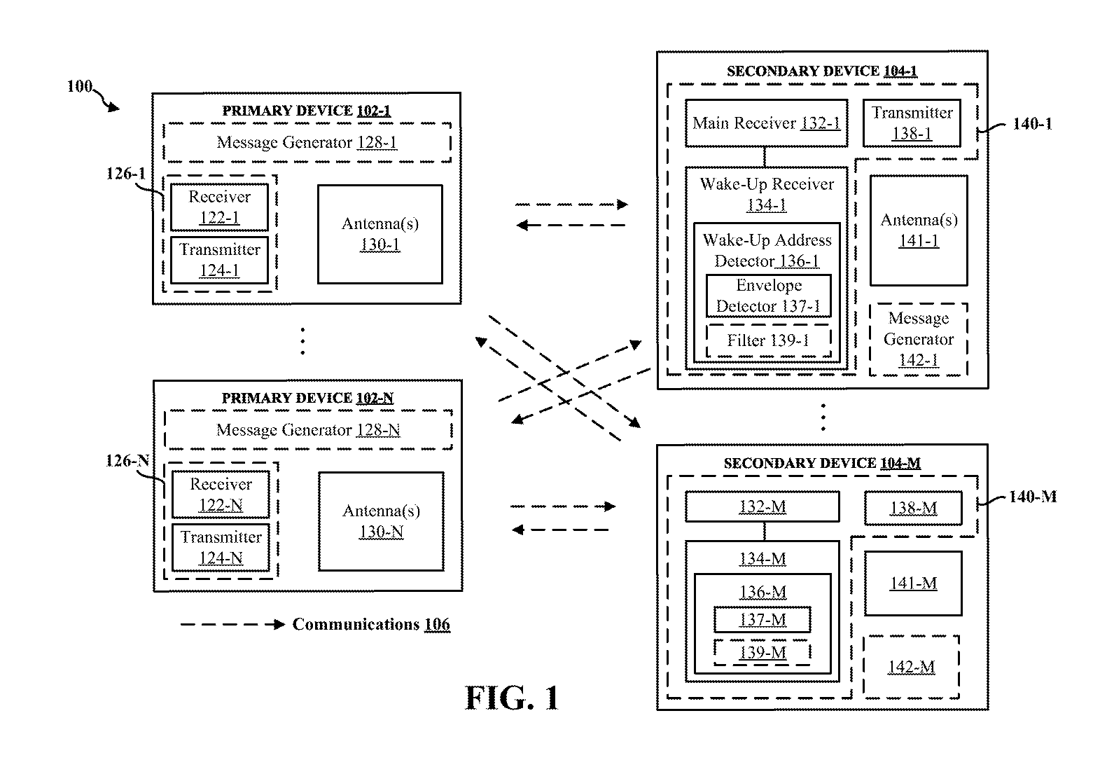

FIG. 1 illustrates an example wireless communication system 100 in which one or more wake-up techniques described herein may be employed. The wireless communication system 100 may include a plurality of wireless devices. For example, the wireless communication system 100 may include one or more primary devices 102-1 through 102-N and one or more secondary devices 104-1 through 104-M. In the example of FIG. 1, the one or more primary devices 102-1 through 102-N is depicted as a first primary device 102-1 and an Nth primary device 102-N, wherein N is a positive integer. The ellipse between the first primary device 102-1 and the Nth primary device 102-N represents any number of primary devices between 102-1 and 102-N. Reference to a non-illustrated primary device may refer to 102-N or a primary device represented by the ellipse between 102-1 and 102-N. For example, reference to a second primary device 102-2 may refer to Nth primary device 102-N if N=2, or a primary device other than the first primary device 102-1 and the Nth primary device 102-N if N>2. Similarly, the one or more secondary devices 104-1 through 104-M is depicted as a first secondary device 104-1 and an Mth secondary device 104-M, wherein M is a positive integer. The ellipse between the first secondary device 104-1 and the Mth secondary device 104-M represents any number of secondary devices between 104-1 and 104-M. Reference to a non-illustrated secondary device may refer to 104-M or a secondary device represented by the ellipse between 104-1 and 104-M. For example, reference to a second secondary device 104-2 may refer to Mth secondary device 104-M if N=2, or a secondary device other than the first secondary device 104-1 and the Mth secondary device 104-M if N>2. In some examples, N may be less than M. In other examples, N may be greater than M. In other examples, N may be equal to M.

In some examples, a primary device may refer to a device that does not include a wake-up receiver, and a secondary device may refer to a device that includes a main receiver communicatively coupled to a wake-up receiver. The wake-up receiver of the secondary device may be configured to awaken or otherwise activate the main receiver from an inactive state based upon a trigger event. The trigger event may include reception of a wake-up address associated with the secondary device. In some examples, a wake-up address associated with the secondary device may include a wake-up address corresponding to the wake-up receiver. In other examples, a wake-up address associated with the secondary device may include a wake-up address corresponding to the main receiver. In other examples, a wake-up address associated with the secondary device may include a wake-up address corresponding to the secondary device.

As used herein, a primary device may refer to a base station, an access point, a station, a wireless device, a peripheral computing device, a user equipment (UE), a wireless phone, a cellular phone, a smart phone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, a thermostat, a hearing aid, a blood glucose on-body unit, an Internet-of-Things (IoT) device, or any other device configured to perform the functions described herein with respect to a primary device.

As used herein, a secondary device may refer to an access point, a station, a wireless device, a peripheral computing device, a UE, a wireless phone, a cellular phone, a smart phone, a SIP phone, a mobile STA, a laptop, a PC, a desktop computer, a PDA, a satellite radio, a global positioning system, a multimedia device, a video device, a digital audio player (e.g., MP3 player), a camera, a game console, a tablet, a smart device, a wearable device, a vehicle, an electric meter, a gas pump, a toaster, a thermostat, a hearing aid, a blood glucose on-body unit, an IoT device, or any other device configured to perform the functions described herein with respect to a secondary device. In some examples, a secondary device may not refer to a base station.

Reference to a primary device 102 may refer to any primary device of the one or more primary devices 102-1 through 102-N. Similarly, reference to a secondary device 104 may refer to any secondary device of the one or more secondary devices 104-1 through 104-M. For example, reference to a primary device 102 being configured to transmit a wake-up message to a secondary device 104 may include reference to a particular primary device of the one or more primary devices 102-1 through 102-N being configured to transmit a wake-up message to a particular secondary device of the one or more secondary devices 104-1 through 104-M. As another example, reference to a secondary device 104 being configured to receive a wake-up message from a primary device 102 may include reference to a particular secondary device of the one or more secondary devices 104-1 through 104-M being configured to receive a wake-up message from a particular primary device of the one or more primary devices 102-1 through 102-N.

A primary device 102 may include one or more components for performing various functions. A primary device 102 includes a receiver 122, a transmitter 124, and one or more antennas 130. The receiver 122 may be communicatively coupled to at least one of the one or more antennas 130. The transmitter 124 may be communicatively coupled to at least one of the one or more antennas 130. In some examples, one or more antennas to which the receiver 122 is communicatively coupled may include one or more antennas to which the transmitter 124 is communicatively coupled. The transmitter 124 may be configured to perform any transmitting function described herein. In some examples, the transmitter 124 may be configured to send a wake-up message to a secondary device 104 as described herein. The receiver 122 may be configured to perform any receiving function described herein. In some examples, the receiver 122 may be configured to receive an instruction to generate a wake-up message, or receive an acknowledgement message that a main receiver of a secondary device 104 is awake (which may be referred to as a wake-up acknowledgement message) as described herein. For example, the receiver 122 may be configured to receive a wake-up acknowledgement message from a transmitter (e.g., a transmitter of the secondary device 104 that includes the awoken or otherwise activated main receiver). The receiver 122 and the transmitter 124 may be combined into a transceiver 126.

In some examples, a primary device 102 may include a message generator 128 configured to generate a wake-up message as described herein. For example, the message generator 128 may be configured to generate a wake-up message for a secondary device 104 in response to a trigger event. The message generator 128 may be configured to send the generated wake-up message to the transmitter 124. The transmitter 124 may be configured to transmit the generated wake-up message to the secondary device 104.

In the example of FIG. 1, the receiver 122, the transmitter 124, the transceiver 126, the one or more antennas 130, and the message generator 128 are illustrated in each of the depicted primary devices. For example, the first primary device 102-1 is shown as including the receiver 122-1, the transmitter 124-1, and the one or more antennas 130-1. The receiver 122-1 and the transmitter 124-1 may be combined into the transceiver 126-1. Similarly, the first primary device 102-1 may include the message generator 128-1. As another example, the Nth primary device 102-N is shown as including the receiver 122-N and the transmitter 124-N. The receiver 122-N and the transmitter 124-N may be combined into the transceiver 126-N. Similarly, the Nth primary device 102-N may include the message generator 128-N.

A secondary device 104 may include one or more components for performing various functions. A secondary device 104 includes a main receiver 132, a wake-up receiver 134 including a wake-up address detector 136, a transmitter 138, and one or more antennas 141. The wake-up address detector 136 may include an envelope detector 137. The wake-up address detector 136 may include a filter 139. The main receiver 132 may be configured to receive and process signals (e.g., information) when in an active mode and may be configured to not receive nor process signals when in an inactive mode. The wake-up receiver 134 may be configured to perform any receiving function described herein relative to a wake-up receiver. For example, the wake-up receiver 134 may be configured to receive information, such as a message. The wake-up address detector 136 may be configured to perform wake-up address detection. For example, the wake-up address detector 136 may be configured to determine whether received information is a wake-up message that includes a wake-up address associated with the device in which the wake-up receiver 134 resides. Based upon whether the received information is the requisite wake-up message, the wake-up address detector 136 may be configured to wake-up (e.g., activate) the main receiver 132 or not wake-up (e.g., not activate) the main receiver 132.

To determine whether the received information is a wake-up message, the wake-up receiver 134 may include the envelope detector 137 that may be configured to perform envelope detection on received information. Received information may constitute any received transmission. A transmission may also be referred to as a signal. The envelope detector 137 may be configured to receive information (e.g., a received signal) and output an envelope corresponding to the received information (e.g., the received signal). The wake-up address detector 136 may be configured to generate an address based on the envelope of the received information. An address generated based on the envelope of received information may be referred to as a decoded address. To generate a decoded address, the wake-up address detector 136 may be configured to convert the envelope into a plurality of address values, where each address value in combination is the decoded address. For example, an envelope of received information may include a sequence of pulses, such as a first pulse, a second pulse, and a third pulse. In such an example, the first and third pulses may be ON-pulses and the second pulse may be an OFF-pulse positioned between the first and third pulses. The first pulse may correspond to a first address value and the third pulse may correspond to a third address value. When combined (e.g., concatenated), the first and third address values may constitute the decoded address.

In some examples, the wake-up receiver 134 may receive information that does not constitute a wake-up message. Therefore, the wake-up receiver 134 may include the filter 139 to filter a wake-up message from non-wake-up information (e.g., any transmitted information that does not constitute a wake-up message). For example, the filter 139 of the wake-up receiver 134 may be configured to determine that received information does or does not constitute a wake-up message based on one or more criteria corresponding to the envelope of the received information. Otherwise described, the filter 139 may be configured to determine that received information constitutes a wake-up message when the received information satisfies each of the one or more criteria corresponding to the envelope of the received information. Based upon whether the received information is the requisite wake-up message, the wake-up address detector 136 may be configured to wake-up the main receiver 132 or not wake-up the main receiver 132. For example, based on the determination (e.g., in response to the determination) that the received information constitutes a wake-up message, the wake-up address detector 136 may be configured to generate an address based on the envelope of the received information. The wake-up address detector 136 may be configured to compare the generated address (which may also be referred to as a decoded address) to the address associated with the secondary device 104. If the decoded address matches the wake-up address associated with the secondary device 104, the wake-up address detector 136 may be configured to wake-up the main receiver 132. If the decoded address does not match the wake-up address associated with the secondary device 104, the wake-up address detector 136 may be configured to not wake-up the main receiver 132.

The main receiver 132 may be communicatively coupled to at least one of the one or more antennas 141. The wake-up receiver 134 may be communicatively coupled to at least one of the one or more antennas 141. The transmitter 138 may be communicatively coupled to at least one of the one or more antennas 141. In some examples, one or more antennas to which the main receiver 132 is communicatively coupled may include one or more antennas to which the wake-up receiver 134 is communicatively coupled. In some examples, one or more antennas to which the main receiver 132 and the wake-up receiver 134 are communicatively coupled may include one or more antennas to which the transmitter 138 is communicatively coupled. The main receiver 132, the wake-up receiver 134, and the transmitter 138 may be combined into a transceiver 140. The transmitter 138 may be configured to perform any transmitting function described herein. The main receiver 132 and the wake-up receiver 134 may be communicatively coupled. The wake-up receiver 134 may be configured to awaken or activate the main receiver 132 from an inactive state based upon a trigger event. The trigger event may include reception of a wake-up message that includes a wake-up address associated with the secondary device 104 that includes the wake-up receiver 134. In some examples, a wake-up address associated with the secondary device 104 may include a wake-up address corresponding to the wake-up receiver 134. In other examples, a wake-up address associated with the secondary device 104 may include a wake-up address corresponding to the main receiver 132. In other examples, a wake-up address associated with the secondary device 104 may include a wake-up address corresponding to the secondary device 104.

The wake-up receiver 134 may be configured to operate with less power and/or less current compared to the main receiver 132. In some examples, the wake-up receiver 134 may be configured to consume less than 10 microamps (uA) (e.g., 1 uA, 2 uA, 3, uA, etc.) when receiving and processing a signal (which may include or may not include a wake-up message as described herein). Due to the low power consumption of the wake-up receiver 134, the wake-up receiver may have less components than the main receiver 132 and the wake-up receiver 134 may be configured to perform fewer functions than the main receiver 132 as a result. For example, the wake-up receiver 134 may not include a local oscillator, whereas the main receiver 132 may include a local oscillator. As another example, the wake-up receiver 134 may be configured to not perform any amplification of a received signal. In such an example, the wake-up receiver 134 may not include a signal amplifier, such as a low noise amplifier. Conversely, in some examples, the main receiver 132 may be configured to perform amplification of a received signal, such as low noise amplification. In such examples, the main receiver 132 may include a signal amplifier (e.g., a low noise amplifier). As another example, the wake-up receiver 134 may include the envelope detector 137, but may not include a demodulator. In such an example, the wake-up receiver 134 may be configured to not coherently demodulate a received signal. Instead, the envelope detector 137 may be configured to detect an envelope of received information (e.g., a received signal) and perform wake-up address detection based on the envelope of the received information. Depending on the context, reference to information (e.g., a message) may refer to a signal or transmission representative of the information (e.g., a signal or transmission representative of a message). For example, the wake-up receiver 134 may be configured to receive information. The information may be a wake-up message. In such an example, the received information may be a signal representative of the wake-up message. Unlike the wake-up receiver 134 in some examples, the main receiver 132 includes a coherent demodulator. The coherent demodulator of the main receiver 132 may be configured to perform a reciprocal process to that of a modulation process, such as the modulation process performed by a transmitter of a device that transmitted the signal received by wake-up receiver 134.

In some examples, the wake-up receiver 134 may be on all the time. Otherwise described, the wake-up receiver 134 may always be active, meaning that the wake-up receiver 134 may be configured to always receive and process signals. Conversely, the main receiver 132 may be configured to enter an inactive or sleep mode until awakened by the wake-up receiver 134 to reduce battery drain (e.g., prevent unnecessary battery drain). While the main receiver 132 is in an inactive mode (e.g., not powered-on, not drawing significant current, not consuming any power, not capable of receiving any signals), the wake-up receiver 134 is in an active mode during which the wake-up receiver 134 may be configured to process received signals. Upon receiving a wake-up message that includes a wake-up address that matches a wake-up address associated with the secondary device 104 (e.g., a wake-up address corresponding to the wake-up receiver 134, the main receiver 132, or the secondary device 104), the wake-up receiver 134 may be configured to activate (e.g., wake-up) the main receiver 132. For example, the wake-up receiver may be configured to output an activation signal to the main receiver 132. Upon receiving the activation signal from the wake-up receiver 134, the main receiver 132 may be configured to enter an active mode during which the main receiver 132 may be configured to receive and process signals. For example, when awake (e.g., in an active mode), the main receiver may be configured to receive and process received signals; and, when asleep (e.g., in an inactive mode), the main receiver 132 may be configured to not process any signals received by any antenna communicatively coupled to the main receiver 132.

In some examples, the main receiver 132 may be configured to enter an active mode or an inactive mode according to a schedule to save power. However, in such examples, the main receiver 132 may enter an active mode and not receive any information (e.g., a message transmission) because the active/inactive schedule may not correspond to information delivery. Therefore, there remains a need for more efficiently controlling when the main receiver 132 wakes up. The techniques described herein relate to providing more precise and/or efficient control over when the main receiver 132 wakes up, which may ensure that the battery of the secondary device 104 is more efficiently utilized. The techniques described herein relate to one or more techniques for generating a wake-up message, transmitting a wake-up message, and/or triggering the wake-up of a main receiver via a wake-up receiver. In accordance with the techniques described herein, battery drain of a secondary device may be reduced by, for example, supplementing or supplanting an inactive/active mode schedule. As an example, battery drain of a secondary device may be reduced by triggering the wake-up of a main receiver only when data is available for transmission to the secondary device.

As described herein, the wake-up receiver 134 may be configured to receive a wake-up message from another device. The wake-up message may be received as a transmitted signal (e.g., a wake-up message transmitted by a primary device). The wake-up receiver 134 may be configured to input the signal representing the wake-up message into the envelope detector 137 of the wake-up address detector 136 to perform envelope detection on the wake-up message. The wake-up address detector 136 may be configured to perform wake-up address detection based on the envelope of the wake-up message.

In some examples, the wake-up receiver 134 may be configured to receive any signal, such as any signal (e.g., radio signal) within the frequency range of the one or more antennas 141 of the secondary device 104. A received signal may be modulated according to any modulation scheme, such as a frequency modulation (FM) scheme, an amplitude modulation (AM) scheme, or any other modulation scheme. The wake-up receiver 134 (e.g., via filter 139) may be configured to discard or otherwise filter any signal that does not constitute a wake-up message. For example, while the first secondary device 104-1 may receive a wake-up message having an address associated with the first secondary device 104-1 from the first primary device 102-1, the first secondary device 104-1 may also receive one or more other signals from the first primary device 102-1 and/or one or more different devices (e.g., one or more primary devices different from the first primary device 102-1 and/or one or more secondary devices different from the first secondary device 104-1). In such an example, the wake-up receiver 134-1 may be configured to discard or otherwise filter out any signal that is not a wake-up message. However, because the first secondary device 104-1 may receive one or more wake-up messages intended for other devices, the wake-up receiver 134-1 may be configured to compare the address associated with a received wake-up message to the address associated with the address associated with the first secondary device 104-1 before waking up the main receiver 132. For example, the wake-up address detector 136 may be configured to compare the address associated with a wake-up message to the address associated with the secondary device 104. If the compared addresses match, the wake-up address detector 136 may be configured to wake-up the main receiver 132. If the compared address does not match, the wake-up address detector 136 may be configured to not wake-up the main receiver 132.

In some examples, a secondary device 104 may include a message generator 142 configured to generate a wake-up acknowledgement message as described herein. For example, the message generator 142 may be configured to generate a wake-up acknowledgement message to send to a primary device 102 from which the secondary device 104 received a wake-up message. For example, the message generator 142 may be configured to generate a wake-up acknowledgement message in response to a trigger event. In some examples, the trigger event may include a determination by the wake-up receiver 134 that an address associated with or otherwise corresponding to a received wake-up message matches the address of the secondary device 104. In other examples, the trigger event may include the output of an activation signal by the wake-up receiver 134 to the main receiver 132. In other examples, the trigger event may include the main receiver 132 entering an active state. The message generator 142 may be configured to send the generated wake-up acknowledgement message to the transmitter 138. The transmitter 138 may be configured to transmit the generated wake-up acknowledgement message to the primary device 102 from which the secondary device 104 received the wake-up message that caused the main receiver 132 to be activated.

In the example of FIG. 1, the main receiver 132, the wake-up receiver 134 including a wake-up address detector 136, the transmitter 138, the transceiver 140, and the message generator 142 are illustrated in each of the depicted secondary devices. For example, the first secondary device 104-1 is shown as including the main receiver 132-1, the wake-up receiver 134-1 including a wake-up address detector 136-1, and the transmitter 138-1. The wake-up address detector 136-1 is shown as including the envelope detector 137-1. In some examples, the wake-up address detector 136-1 may include the filter 139-1. The main receiver 132-1, the wake-up receiver 134-1, and the transmitter 138-1 may be combined into the transceiver 140-1. Similarly, the first secondary device 104-1 may include the message generator 142-1. As another example, the Mth secondary device 104-M is shown as including the main receiver 132-M, the wake-up receiver 134-M including a wake-up address detector 136-M, and the transmitter 138-M. The wake-up address detector 136-M is shown as including the envelope detector 137-M. In some examples, the wake-up address detector 136-1 may include the filter 139-M. The main receiver 132-M, the wake-up receiver 134-M, and the transmitter 138-M may be combined into the transceiver 140-M. Similarly, the Mth secondary device 104-M may include the message generator 142-M.

Each primary device of the one or more primary devices 102-1 through 102-N may be configured to operate in accordance with one or more communication protocols. For example, each primary device of the one or more primary devices 102-1 through 102-N may be configured to communicate with (e.g., receive information from and/or transmit information to) one or more other devices (e.g., one or more other primary devices and/or one or more secondary devices) in accordance with one or more communication protocols. As another example, each primary device of the one or more primary devices 102-1 through 102-N may be communicatively coupled to one or more other devices (e.g., one or more other primary devices and/or one or more secondary devices) over one or more connections. Each connection may be compliant or otherwise be in accordance with a communication protocol.

Similarly, each secondary device of the one or more secondary devices 104-1 through 104-M may be configured to operate in accordance with one or more communication protocols. For example, each secondary device of the one or more secondary devices 104-1 through 104-M may be configured to communicate with (e.g., receive information from and/or transmit information to) one or more other devices (e.g., one or more primary devices and/or one or more other secondary devices) in accordance with one or more communication protocols. As another example, each secondary device of the one or more secondary devices 104-1 through 104-M may be communicatively coupled to one or more other devices (e.g., one or more primary devices and/or one or more other secondary devices) over one or more connections. Each connection may be compliant or otherwise be in accordance with a communication protocol.

As used herein, the term “communication protocol” may refer to any communication protocol, such as a communication protocol compliant with a communication standard or the like. As used herein, the term “communication standard” may include any wireless communication standard. A wireless communication standard may correspond to a wireless network. As an example, a communication standard may include any wireless communication standard corresponding to a wireless personal area network (WPAN) standard, such as Bluetooth (e.g., IEEE 802.15), Bluetooth low energy (BLE) (e.g., IEEE 802.15.4). As another example, a communication standard may include any wireless communication standard corresponding to a wireless local area network (WLAN) standard, such as WI-FI (e.g., any 802.11 standard, such as 802.11a, 802.11b, 802.11c, 802.11n, or 802.11ax). As another example, a communication standard may include any wireless communication standard corresponding to a wireless wide area network (WWAN) standard, such as 3G, 4G, 4G LTE, or 5G.

As used herein, the term “communicatively coupled” may refer to a communication connection, which may be direct or indirect. A communication connection may be wired and/or wireless. A wired connection may refer to a conductive path, a trace, or a physical medium (excluding wireless physical mediums) over which information may travel. A conductive path may refer to any conductor of any length, such as a conductive pad, a conductive via, a conductive plane, a conductive trace, or any conductive medium. A direct communication connection may refer to a connection in which no intermediary component or device resides between the two communicatively coupled components or devices. An indirect communication connection may refer to a connection in which at least one intermediary component or device resides between the two communicatively coupled components or devices.

Referring to the example of FIG. 1, each primary device 102-1 through 102-N may be configured to wirelessly communicate with one or more secondary devices 104-1 through 104-M, and each secondary device 104-1 through 104-M may be configured to wirelessly communicate with one or more primary devices 102-1 through 102-N. In some examples, a primary device may be configured to communicate with one or more other primary devices. Similarly, a secondary device may be configured to communicate with one or more other secondary devices. As referenced herein, a device (e.g., a primary device or a secondary device) being configured to communicate with another device may be described as being configured to receive one or more packets in accordance with a communication protocol and/or transmit one or more packets in accordance with a communication protocol. A message may include a plurality of packets. For example, referring to reception, a device may be configured to receive one or more packets on one or more carrier signals received on one or more antennas. As another example, referring to transmission, after generating one or more packets, the device may be configured to modulate the one or more packets onto one or more carrier signals. The device may be configured to transmit the one or more carrier signals using one or more antennas. In some examples, one or more antennas used to receive information may be the same one or more antennas used to transmit information.

As used herein, a packet may refer to a plurality of bits. For example, a packet may include two or more bits. Packets may vary by length. Modulation of a packet onto a carrier signal may result in a packet having an envelope with a length, where the length of the modulated packet (i.e., the length of the envelope corresponding to the modulated packet) is associated with the length of the unmodulated packet. Otherwise described, the length of an unmodulated packet may be measured in bits, whereas the length of a modulated packet may be measured in time. For example, a packet having a bit length of X may be a time period of Y in length, where X and Y are numbers. The value Y may depend on the modulation scheme used to modulate a packet that is X bits in length. In some examples, X may equal Y. For example, a packet having a bit length of 137 may be a time period of 137 in length (e.g., 137 microseconds). In other examples, X may not equal Y. In such examples, Y may be a function of X. For example, Y may be based on X in that the modulation of an unmodulated packet X bits in length results in a modulated packet having a time period of length Y. In some examples, Y may be less than X. In other examples, Y may be greater than X. A time period may refer to a time value. In some examples, the time associated with an ON-pulse described herein may correspond to Y. For example, the time associated with an ON-pulse described herein may correspond to a measured value of Y.

In some examples, a packet may conform to a communication protocol. For example, a packet may be an 802.11 packet. As another example, a packet may be an 802.15 packet. As another example, a packet may be an 802.15.4 packet. A packet may include one or more fields. The one or more fields of a packet may include a data field and one or more additional fields. The data field may, in some examples, be referred to as a payload field. The one or more fields of a packet may include a preamble field, a header field, a cyclic redundancy check (CRC) field, or the like.

As used herein, a message may refer to a plurality of packets. For example, a wake-up message described herein includes a plurality of packets. The length of each packet in the wake-up message corresponds to a value associated with a wake-up address. A wake-up message is described in more detail herein.

In some examples, each primary device of the one or more primary devices 102-1 through 102-N may provide communication coverage for a respective coverage area. There may be overlapping coverage areas. The communications 106 depicted in the example of FIG. 1 may include one or more uplink (UL) (also referred to as reverse link) transmissions and/or one or more downlink (DL) (also referred to as forward link) transmissions. A transmission may include one or more packets. One or more of the illustrated communications 106 may include a wake-up message and/or one or more of the illustrated communications 106 may not include a wake-up message. In some examples, a UL transmission may be transmitted by a primary device and received by a secondary device, and a DL transmission may be transmitted by a secondary device and received by a primary device. In other examples, a UL transmission may be transmitted by a secondary device and received by a primary device, and a DL transmission may be transmitted by a primary device and received by a secondary device.

A primary device 102 and/or a secondary device 104 may use multiple-input and multiple-output (MIMO) antenna technology, including spatial multiplexing, beamforming, and/or transmit diversity. The communications 106 may be through one or more carriers signals (also referred to as carriers). In some examples, the one or more primary devices 102-1 through 102-N and/or the one or more secondary devices 104-1 through 104-M may use spectrum up to A BHz bandwidth per carrier allocated in a carrier aggregation of up to a total of Ax BHz (where x represents one or more component carriers) used for transmission in each direction. The value A may be any value, such as 1, 2.4, 5, 10, 15, 20, 100 or more. B may be any abbreviation for any number measurement. For example, B may be M for mega meaning BHz would be MHz (megahertz), or B may be G for giga meaning BHz would be GHz (gigahertz). The carriers may or may not be adjacent to each other.

A transmission (e.g., a UL transmission or a DL transmission) may include information destined for one or more recipient devices. For example, with reference to the example of FIG. 1, the first primary device 102-1 may be configured to transmit information to a second primary device 102-2 and the first secondary device 104-1. In this example, the second primary device 102-2 and the first secondary device 104-1 may be referred to as recipients (or destinations) of information transmitted by the first primary device 102-1. In some examples, the information transmitted to first secondary device 104-1 may be in accordance with a first communication protocol, and the information transmitted to the second primary device 102-2 may be in accordance with a second communication protocol. In such examples, the first and second communication protocols may be different. In some examples, a device (e.g., a primary device or a secondary device) may receive information that was not destined for the device. For example, the second secondary device 104-2 in FIG. 1 may receive information transmitted by the first primary device 102-1 to the second primary device 102-2 and/or the first secondary device 104-1.

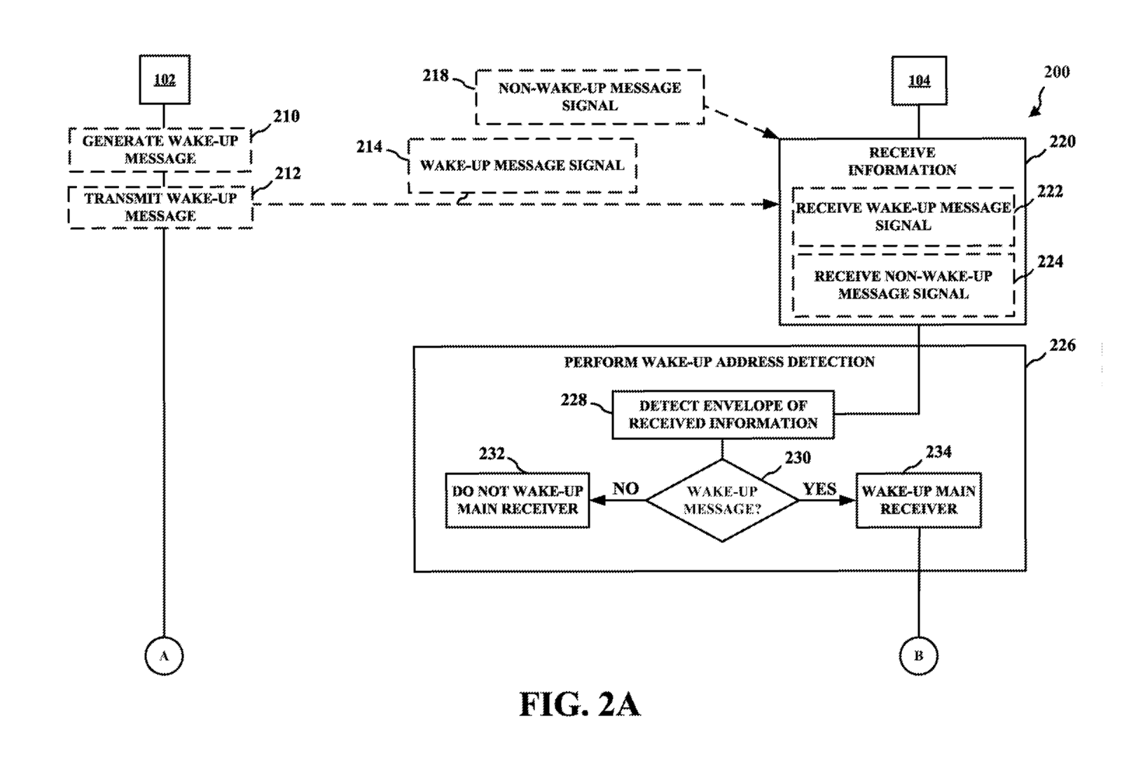

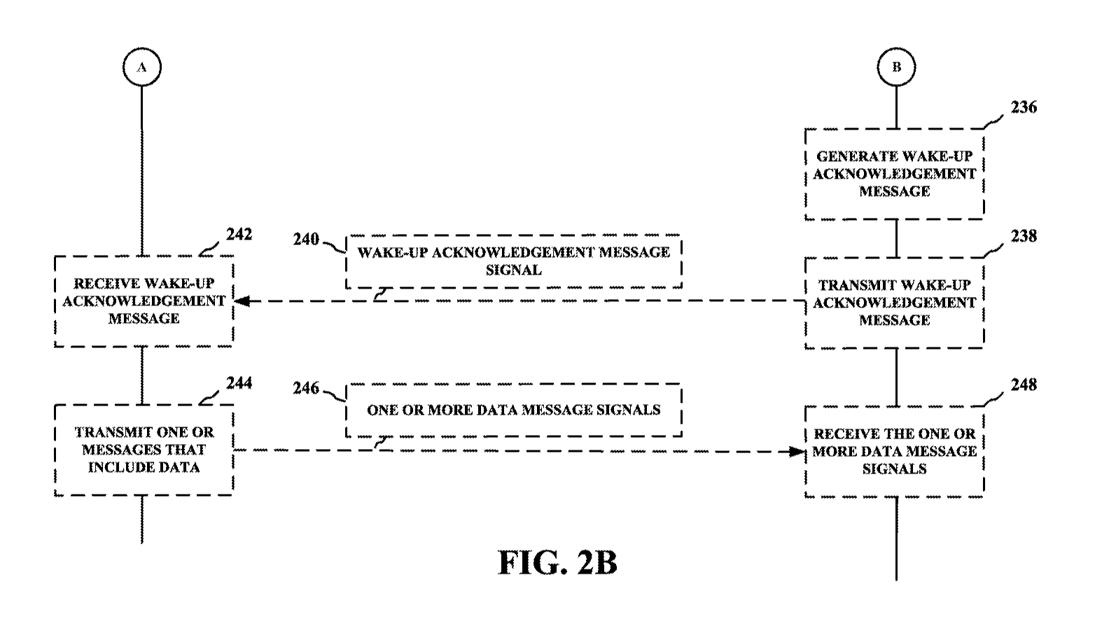

FIGS. 2A-B illustrate an example flow diagram 200 between a primary device 102 and a secondary device 104 in accordance with one or more techniques of this disclosure. In the example of FIGS. 2A-B, the primary device 102 may be configured to communicate with the secondary device 104. In other examples, one or more techniques described herein may be added to the flow diagram 200 and/or one or more techniques depicted in the flow diagram may be removed. The primary device 102 may be any primary device configured to perform one or more techniques described herein. For example, the primary device 102 may be one of the one or more primary devices 102-1 through 102-N, apparatus 1002, apparatus 1102′, or any other primary device configured to perform one or more techniques described herein. Similarly, the secondary device 104 may be any secondary device configured to perform one or more techniques described herein. For example, the secondary device 104 may be one of the one or more secondary devices 104-1 through 104-M, apparatus 804, apparatus 904′, or any other secondary device configured to perform one or more techniques described herein.

At block 210, the message generator 128 of the primary device 102 may be configured to generate a wake-up message for instructing the wake-up receiver 134 of the secondary device 104 to activate (e.g., wake-up) the main receiver 132 of the secondary device 104. In some examples, the primary device 102 may be configured to generate a wake-up message for the secondary device 104 based on (e.g., in response to) a trigger event.

For example, the receiver 122 of the primary device 102 may receive an instruction to generate a wake-up message for the secondary device 104. In such an example, another device different from the particular primary device 102 and particular secondary device 104 described with respect to FIGS. 2A-B may transmit the instruction to generate a wake-up message to the primary device 102. In response to reception of the instruction to generate the wake-up instruction for the secondary device 104, the message generator 128 may be configured to generate the wake-up message. For example, the message generator 128 may be configured to receive the instruction; and, in response to reception of the instruction, the message generator may be configured to generate a wake-up message. Therefore, the trigger event to generate a wake-up message may include reception of an instruction from another device to generate a wake-up message. The instruction may include a wake-up address associated with the secondary device 104.

As another example, the primary device 102 may be configured to generate an instruction to generate a wake-up message. For example, the message generator 128 may be configured to receive the instruction; and, in response to reception of the instruction, the message generator may be configured to generate a wake-up message. Therefore, the trigger event to generate a wake-up message may include reception of an instruction generated by a component of the primary device 102 (e.g., a processing unit of the primary device 102). The instruction may include a wake-up address associated with the secondary device 104.

As another example, the trigger event may include a determination that there is data available for transmission to the secondary device 104. In such an example, the message generator 128 may be configured to determine whether the primary device 102 has any information (e.g., data) available for transmission to the secondary device 104. If information (e.g., data) is not available, then the message generator 128 may be configured to not generate a wake-up message for activating the main receiver 132 of the secondary device 104. If information (e.g., data) is available, then the message generator 128 may be configured to generate a wake-up message for activating the main receiver 132 of the secondary device 104. The secondary device 104 may include a wake-up address associated therewith.

To generate the wake-up message at block 210, the message generator 128 may be configured to encode a wake-up address associated with the secondary device 104 into a plurality of packets. For example, the message generator 128 may be configured to encode a wake-up address associated with the secondary device 104 into a plurality of packets according to an N-bit encoding scheme described herein. The length of each packet in combination may be representative of the wake-up address. Otherwise described, the length of each packet in the wake-up message corresponds to a respective value associated with the wake-up address. In some examples, at least two packets of the plurality of packets of the wake-up message vary in packet length by a multiple of a packet length variance value. The wake-up address is a plurality of bits in length. For example, the wake-up address may be 128 bits in length. As another example, the wake-up address may be less than 128 bits in length. As another example, the wake-up address may be greater than 128 bits in length.

In some examples, each packet of a generated wake-up message has a length that is greater than the number of bits of the address to which the packet corresponds. In such examples, if a wake-up address is 256 bits in length and a 3-bit encoding scheme is used, the wake-up address may include 86 packets (derived by dividing 256 by 3, which equals 85.3). Since the address does not evenly divide, one of the packets (e.g., the first packet, the last packet, or any other packet of the 86 packets of the wake-up message) may be padded with one or more bits (e.g., one or more 0s, one or more 1s, or a combination thereof) to provide a known value or pattern that corresponds to values that do not correspond to a wake-up address for each missing bit. In the 256-bit wake-up address example, only one bit may be padded. However, if the wake-up address was 17-bits in length, two bits may be padded to compensate for the two bits in one of the packets that would not correspond to the address. In the 256-bit wake-up address example, the packet length of each of the 86 packets may be greater than 3 bits even though the packet length of each packet represents a respective 3-bit value.

In accordance with the N-bit encoding scheme (where N is a positive integer), 2^{N} represents the number of available packet lengths that may be used to encode a wake-up address and N represents the number of bits each packet length may represent. For example, where N=2, the message generator 128 may be configured to encode a wake-up address using any combination of packets having a first packet length, a second packet length, a third packet length, or a fourth packet length. Each of the first, second, third, and fourth packet lengths represent a respective 2-bit value. For example, the first packet length may represent the value 00, the second packet length may represent the value 01, the third packet length may represent the value 10, and the fourth packet length may represent the value 11. As an example, where N=2, the message generator 128 may be configured to encode a wake-up address of 0010110010 into a wake-up message including five packets, where the length of the first packet may represent the value of 00, the length of the second packet may represent the value of 10, the length of the third packet may represent the value 11, the length of the fourth packet may represent the value 00, and the length of the fifth packet may represent the value 10. In this example, the first and fourth packets have the same length because they both represent the same value of 00. Similarly, the second and fifth packets in this example have the same length because they both represent the same value of 10.

In accordance with the N-bit encoding scheme, the packets available for encoding a wake-up address may vary in length by a multiple of a packet length variance value, such as M bits (where M is a positive integer). Otherwise described, each packet may vary in length by M bits relative to at least one other packet. In such an example, M may equal 40 bits. In the example of 40 bits, each packet may vary in length by 40 bits relative to at least one other packet. In other examples, an even variance of 40 bits may not occur. Instead, each packet may vary in length by at least one multiple of 40 relative to at least one other packet. For example, as described above, 2^{N} represents the number of packet lengths that may be used to encode a wake-up address and N represents the number of bits each packet length may represent. If N=2 and the smallest packet length of the four available packet lengths that may be used to encode a wake-up address is X, then the additional packet lengths of the remaining three available packet lengths may include X+M, X+(2*M), and X+(3*M). In other examples, the additional packet lengths of the remaining three available packet lengths may include X+(M*A), X+(M*B), and X+(M*C), where A<B<C and A, B, and C are each a positive integer. For example A may equal 1, B may equal 3, and C may equal 6. In this example, each packet of the four available packets vary in length by at least one multiple of M bits relative to at least one other packet.

In other examples, M may be less than 40 bits or more than 40 bits. The packet lengths themselves may not be a multiple of the packet length variance value. Instead, the difference between any two packet lengths of the available packets that may be used to encode a wake-up address may be a multiple of the packet length variance value. In some examples, the data rate increases as M decreases, and the data rate decreases as M increases. For example, a very small M value may make it more difficult to distinguish packets, whereas a very large M value may make it very easy to distinguish packets but at the cost of a slow data rate. In some examples, M may be a value ranging from 30 to 50.

Table 1 below illustrates an example of available packets for encoding a wake-up address where N=2. Packets 1, 2, 3, and 4 represent the available packets and their corresponding length that may be used to encode a wake-up address. For example, any packet in a generated wake-up message having a length of X may represent the address value of 00, any packet in a wake-up message having a length of X+40 may represent the address value of 01, any packet in a wake-up message having a length of X+80 may represent the address value of 10, and any packet in a wake-up message having a length of X+120 may represent the address value of 11. The address value may be a binary value. An address value may be N bits in length in accordance with a N-bit encoding scheme. For example, an address value may be 2 bits in length in accordance with a 2-bit encoding scheme. As another example, an address value may be 3 bits in length in accordance with a 3-bit encoding scheme. As another example, an address value may be 4 bits in length in accordance with a 4-bit encoding scheme. The address value may also be referred to as a partial address value. As used herein, an address value or a partial address value are synonymous terms. An address value or a partial address value represents a portion of the wake-up address corresponding to the wake-up message. In the example of Table 1, X represents the minimum bit length among packets 1-4. Otherwise described, packet 1 may have a minimum packet length, whereas packet 4 may have a maximum packet length bounded by being a multiple of M. In some examples, the maximum packet length of packet 4 may be equal to X+(M*(2^{N}−1)). Otherwise described, the maximum packet length of a packet according to an N-bit encoding scheme may be equal to X+(M*(2^{N}−1)), where X represents the minimum bit length among the 2^{N} available packets and M represents the packet length variance value. For example, where N=2 in this example, the maximum packet length is equal to X+120. In Table 1 below, each of the available packets 1-4 vary in length relative to each other by a multiple of M. The mapping of address values to packet lengths may differ from the mapping shown in Table 1 in other examples.

TABLE 1

2-Bit Encoding Data
Structure

| | Packet Length | Address |
|---|---|---|
| Packet | (M = 40) | Value |
| 1 | X bits | 00 |
| 2 | X + 40 bits | 01 |
| 3 | X + 80 bits | 10 |
| 4 | X + 120 bits | 11 |

For example, in accordance with the 2-bit encoding scheme illustrated in Table 1, a wake-up address of 0110 may be configured to generate a wake-up message including two packets of varying length: a first packet 2 and a second packet 3. As another example, in accordance with the 2-bit encoding scheme illustrated in Table 1, a wake-up address of 110010 may be configured to generate a wake-up message including three packets of varying length: a first packet 4, a second packet 1, and a third packet 3. As another example, in accordance with the 2-bit encoding scheme illustrated in Table 1, a wake-up address of 000011 may be configured to generate a wake-up message including three packets of varying length: a first packet 1, a second packet 1, and a third packet 4. In this particular example, while the first packet 1 and the second packet 1 do not vary length relative to each other, they do vary in length relative to at least one packet: the third packet 4. As described above, the packets available for encoding a wake-up address may vary in length by a multiple of a packet length variance value. Therefore, a wake-up message may include at least two packets that vary in length by a multiple of a packet length variance value. In some examples, the wake-up message may include at least two packets that have the same length, meaning that these at least two packets do not vary in length by a multiple of a packet length variance value. In such examples, the at least two packets that have the same length may vary in length relative to at least one other packet included in the wake-up message.

Table 2 below illustrates an example of available packets for encoding a wake-up address where N=3. Packets 1, 2, 3, 4, 5, 6, 7, and 8 represent the available packets and their corresponding length that may be used to encode a wake-up address. For example, any packet in a generated wake-up message having a length of X may represent the address value of 000, any packet in a wake-up message having a length of X+40 may represent the address value of 001, any packet in a wake-up message having a length of X+80 may represent the address value of 010, any packet in a wake-up message having a length of X+120 may represent the address value of 100, any packet in a wake-up message having a length of X+160 may represent the address value of 101, any packet in a wake-up message having a length of X+200 may represent the address value of 110, any packet in a wake-up message having a length of X+240 may represent the address value of 011, and any packet in a wake-up message having a length of X+280 may represent the address value of 111. In the example of Table 2, X represents the minimum bit length among packets 1-8. Otherwise described, packet 1 may have a minimum packet length, whereas packet 8 may have a maximum packet length bounded by being a multiple of M. The maximum packet length of packet 8 may be equal to X+(M*(2^{N}−1)). For example, where N=3 in this example, the maximum packet length is equal to X+280. In Table 2 below, each of the available packets 1-8 vary in length relative to each other by a multiple of M. The mapping of address values to packet lengths may differ from the mapping shown in Table 2 in other examples.

TABLE 2

3-Bit Encoding Data
Structure

| | Packet Length | Address |
|---|---|---|
| Packet | (M = 40) | Value |
| 1 | X bits | 000 |
| 2 | X + 40 bits | 001 |
| 3 | X + 80 bits | 010 |
| 4 | X + 120 bits | 100 |
| 5 | X + 160 bits | 101 |
| 6 | X + 200 bits | 110 |
| 7 | X + 240 bits | 011 |
| 8 | X + 280 bits | 111 |

For example, in accordance with the 3-bit encoding scheme illustrated in Table 2, a wake-up address of 010111 may be configured to generate a wake-up message including two packets of varying length: a first packet 3 and a second packet 8. As another example, in accordance with the 3-bit encoding scheme illustrated in Table 2, a wake-up address of 000111001 may be configured to generate a wake-up message including three packets of varying length: a first packet 1, a second packet 8, and a third packet 2. As another example, in accordance with the 3-bit encoding scheme illustrated in Table 2, a wake-up address of 000000001 may be configured to generate a wake-up message including three packets of varying length: a first packet 1, a second packet 1, and a third packet 2. In this particular example, while the first packet 1 and the second packet 1 do not vary length relative to each other, they do vary in length relative to at least one packet: the third packet 2. Referring to the example of Table 2, X may be 96 bits in some examples, resulting in packets 1-8 having the following respective packet lengths: 96, 136, 176, 216, 256, 296, 336, and 376.

As described above, the packets available for encoding a wake-up address may vary in length by a multiple of a packet length variance value. Therefore, a wake-up message described herein includes a plurality of packets. The plurality of packets includes at least two packets that vary in length by a multiple of a packet length variance value. In some examples, the plurality of packets may include at least two packets that have the same length, meaning that these at least two packets do not vary in length by a multiple of a packet length variance value. In such examples, the at least two packets that have the same length may vary in length relative to at least one or more other packets of the plurality of packets by a multiple of the packet length variance value M.

As described herein, a memory accessible to the message generator 128 may store a data structure that maps a plurality of address values to a plurality of packet lengths. To encode a wake-up address associated with the secondary device 104 into a plurality of packets, the message generator 128 may be configured to encode a wake-up address associated with the secondary device 104 into a plurality of packets according to an N-bit encoding scheme described herein. The length of each packet in combination may be representative of the wake-up address. For example, the message generator 128 may be configured to convert or otherwise parse a wake-up address into a plurality of address values that, in combination, constitute the wake-up address. The plurality of address values stored in the data structure in memory may also be referred to as partial address values since alone each address value may constitute a portion of a wake-up address. The message generator 128 may be configured to compare each address value of a wake-up address to a data structure that maps a plurality of address values to a plurality of packet lengths. Each address value of the plurality of time periods in the data structure may respectively correspond to one packet length. The data structure may constitute a look-up table (LUT), where an input of an address value results in the output of a packet length corresponding to the address value input. For example, to encode a wake-up address, the message generator 128 may be configured to input each address value corresponding to a wake-up address into the data structure resulting in the output of a packet length associated with each address value that was input into the data structure. For each respective packet length output, the message generator may be configured to generate a packet having a length corresponding to the respective packet length output.

In some examples, an N-bit encoding data structure may be stored in a memory of the message generator 128 or a memory accessible by the message generator 128 (e.g., a memory of the primary device 102). The portion of Table 1 above that maps address values to packet lengths (which may also be described as mapping packet lengths to address values) constitutes an example of a data structure stored in a memory of the message generator 128 or a memory accessible by the message generator 128. This data structure may be referred to as an encoding data structure. In the example of Table 1, the example encoding data structure is labeled as a 2-bit encoding data structure.

The portion of Table 2 above that maps address values to packet lengths (which may also be described as mapping packet lengths to address values) constitutes an example of a data structure stored in a memory of the message generator 128 or a memory accessible by the message generator 128. This data structure may be referred to as an encoding data structure. In the example of Table 2, the example encoding data structure is labeled as a 3-bit encoding data structure.

The portion of Table 3 below that maps address values to packet lengths (which may also be described as mapping packet lengths to address values) constitutes an example of a data structure stored in a memory of the message generator 128 or a memory accessible by the message generator 128. This data structure may be referred to as an encoding data structure. In the example of Table 3, the example encoding data structure is labeled as a 2-bit encoding data structure.

The portion of Table 4 below that maps address values to packet lengths (which may also be described as mapping packet lengths to address values) constitutes an example of a data structure stored in a memory of the message generator 128 or a memory accessible by the message generator 128. This data structure may be referred to as an encoding data structure. In the example of Table 4, the example encoding data structure is labeled as a 4-bit encoding data structure.

The portion of Table 5 below that maps address values to packet lengths (which may also be described as mapping packet lengths to address values) constitutes an example of a data structure stored in a memory of the message generator 128 or a memory accessible by the message generator 128. This data structure may be referred to as an encoding data structure. In the example of Table 5, the example encoding data structure is labeled as a 2-bit encoding data structure.

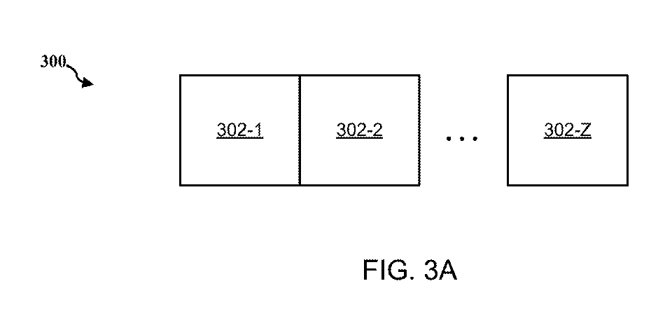

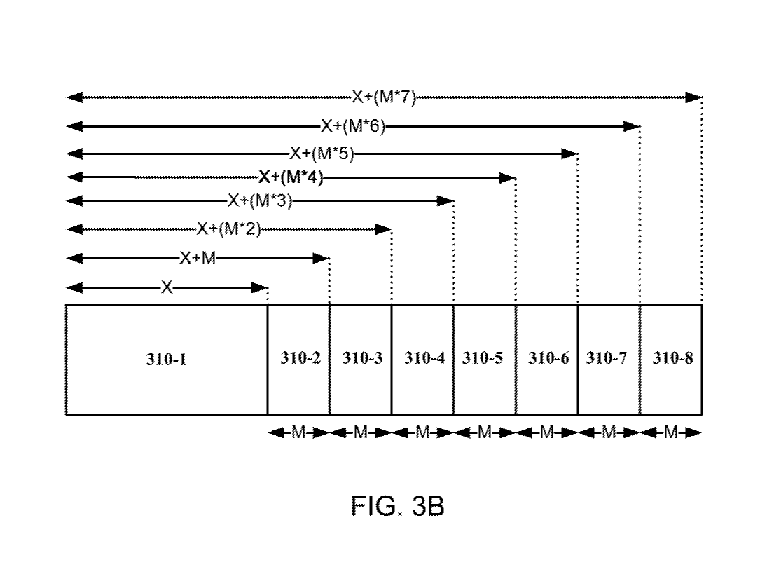

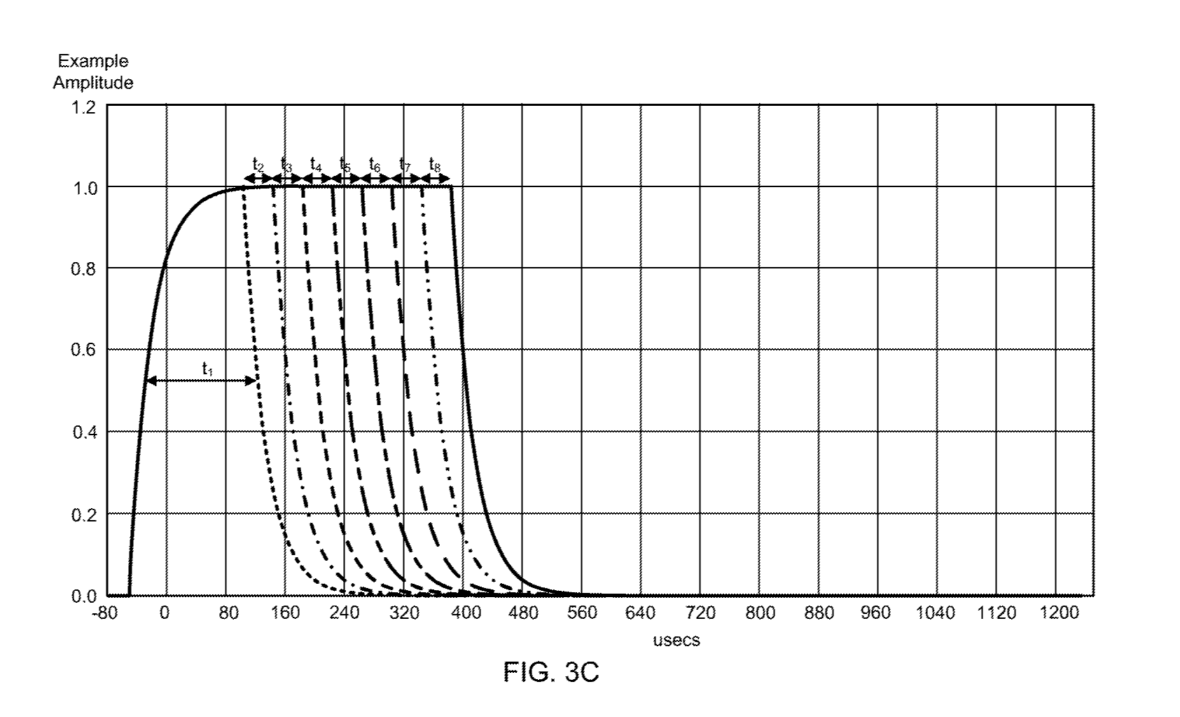

FIG. 3A illustrates an example of a wake-up message 300 that the message generator 128 may be configured to generate to encode a wake-up address. The wake-up message 300 includes a plurality of packets 302-1 through 302-Z, where Z is a positive integer and is the Zth packet of the plurality of packets. In an N-bit encoding scheme described herein, Z may equal the wake-up address to be encoded divided by N rounded up to the nearest integer, where N represents the number of bits each packet length represents. For example, where the wake-up address to be encoded is 4 bits and N=2, then Z=2 (meaning that the wake-up address generated to encode the 4-bit wake-up address would include 2 packets). As another example, where the wake-up address to be encoded is 24 bits and N=2, then Z=12 (meaning that the wake-up address generated to encode the 24-bit wake-up address would include 12 packets). As another example, where the wake-up address to be encoded is 256 bits and N=3, then Z=86 (meaning that the wake-up address generated to encode the 256-bit wake-up address would include 86 packets).

Each of the packets 302-1 through 302-Z have a packet length. The length of each packet 302-1 through 302-Z in combination is representative of a wake-up address. Otherwise described, the length of each packet of the plurality of packets 302-1 through 302-Z in the wake-up message corresponds to a respective value associated with a wake-up address. Each value in combination (e.g., concatenated together) is representative of the wake-up address.

In accordance with the N-bit encoding scheme used to generate the wake-up message 300, 2^{N} represents the number of packet lengths that may be used to encode a wake-up address and N represents the number of bits each packet length may represent. As described above, the packets available for encoding the wake-up address may vary in length by a multiple of a packet length variance value, such as M bits (where M is a positive integer). The packets available for encoding the wake-up address may include a first value or a second value; and, where N>2, one or more values between the first value and the second value. In some examples, the first value may be a minimum packet length, and the second value may be a maximum packet length. In such examples, the minimum packet length may refer to the smallest packet length among the available packet lengths for encoding a wake-up address, and the maximum packet length may refer to the largest packet length among the available packet lengths for encoding a wake-up address. In some examples, the minimum packet length may be equal to X bits, where X is a positive integer. In such examples, the maximum packet length of a packet according to an N-bit encoding scheme may be equal to X+(M*(2^{N}−1)), where X represents the minimum bit length among the 2^{N} available packets and M represents the packet length variance value.

The plurality of packets 302-1 through 302-Z includes at least two packets that vary in length by a multiple of the packet length variance value M. In some examples, the plurality of packets may include at least two packets that have the same length, meaning that these at least two packets do not vary in length by a multiple of a packet length variance value. In such examples, the at least two packets that have the same length may vary in length relative to at least one or more other packets of the plurality of packets by a multiple of the packet length variance value M.

In some examples, the plurality of packets 302-1 through 302-Z of the wake-up message 300 may not include any data other than the wake-up address represented by the length of each packet of the plurality packets. In other examples, the plurality of packets 302-1 through 302-Z of the wake-up message 300 may include data other than the wake-up address represented by the length of each packet of the plurality packets. The data may be encapsulated in the plurality of packets, as opposed to being carried or otherwise represented by the length of the packets.

FIG. 3B illustrates an example of available packet lengths where N=3. Packets 310-1 through 310-8 each respectively have the illustrated length, where M is a packet length variance value. For example, packet 310-1 has a length of X, packet 310-5 has a length of X+(M*4), and packet 310-8 has a length of X+(M*7). FIG. 3C illustrates an example of packet envelopes. For example, the example of FIG. 3C illustrates example envelopes respectively corresponding to each of packets 310-1 through 310-8 illustrated in FIG. 3B. Each tx is a time period, where x is an integer. A time period may refer to a time value. The envelope corresponding to time period t₁ may correspond to packet 310-1. The envelope corresponding to time period (t₁+t₂) may correspond to packet 310-2. The envelope corresponding to time period (t₁+t₂+t₃) may correspond to packet 310-3. The envelope corresponding to time period (t₁++t₃+t₄) may correspond to packet 310-4. The envelope corresponding to time period (t₁+t₂+t₃+t₄+t₅) may correspond to packet 310-5. The envelope corresponding to time period (t₁+t₂+t₃+t₄+t₅+t₆) may correspond to packet 310-6. The envelope corresponding to time period (t₁+t₂+t₃+t₄+t₅+t₆+t₇) may correspond to packet 310-7. The envelope corresponding to time period (t₁+t₂+t₃+t₄+t₅+t₆+t₇+t₈) may correspond to packet 310-8. The example of FIG. 3C is one example of a non-ideal signal (i.e., an example of an actual signal transmission, as opposed to an ideal square wave signal).

Referring back to FIGS. 2A-B, the message generator 128 may be configured to send a generated wake-up message to the transmitter 124. At block 212, the transmitter 124 may be configured to transmit the generated wake-up message to the secondary device 104. In some examples, a transmitted wake-up message may be referred to as a wake-up message transmission or a wake-up message signal. The terms transmission and signal may be synonymous or otherwise interchangeable in some examples. A transmitted wake-up message may be a signal representative of the wake-up message generated by the message generator 128. Block 214 shows the wake-up message transmission.

To transmit the generated wake-up message, the transmitter 124 may be configured to modulate a carrier signal with the generated wake-up message according to a modulation scheme to transmit the wake-up message to the secondary device 104. In some examples, the modulation scheme may include any modulation scheme that may produce ON-pulses and OFF-pulses (e.g., a pulse-width modulation scheme, an on-off-key (OOK) modulation scheme, or the like), where the length of the ON-pulses represent the packets of the wake-up message. An OFF-pulse may separate two ON-pulses by being sequentially positioned between the two ON-pulses. The OFF-pulses may not represent the packets of the wake-up message. In some examples, an ON-pulse may be referred to a modulation-pulse, and an OFF-pulse may refer to a non-modulation pulse. In some examples, an ON-pulse may be referred to as a PACKET-pulse and an OFF-pulse may be referred to as a non-PACKET-pulse. In such examples, a PACKET-pulse corresponds to a modulated pulse corresponding to a packet, and a non-PACKET pulse corresponds to a modulated or unmodulated pulse not corresponding to a packet that is different from a PACKET-pulse and is positioned between two PACKET-pulses. In some examples, the amplitude of an ON-pulse may be greater than the amplitude of an OFF-pulse, the corollary being that an OFF-pulse has an amplitude less than an ON-pulse in such examples. For example, the amplitude of an ON-pulse may be 20 dBm and the amplitude of an OFF-pulse may be −40 dBm. In other examples, the amplitude of an ON-pulse may be less than the amplitude of an OFF-pulse.

The length of each ON-pulse of the wake-up message transmission may correspond to a respective packet length of a generated wake-up message. Each ON-pulse of the wake-up message transmission may be sequentially separated by an OFF-pulse. The length of each OFF-pulse may be based on a communication protocol compliant with a communication standard. In some examples, the length of an OFF-pulse may be referred to as an inter-packet time because the length of an OFF-pulse may separate two ON-pulses of the wake-up message transmission. In some examples, the length of each OFF-pulse of a wake-up message transmission may be the same. In other examples, the length of OFF-pulses in a wake-up message transmission may vary in length.

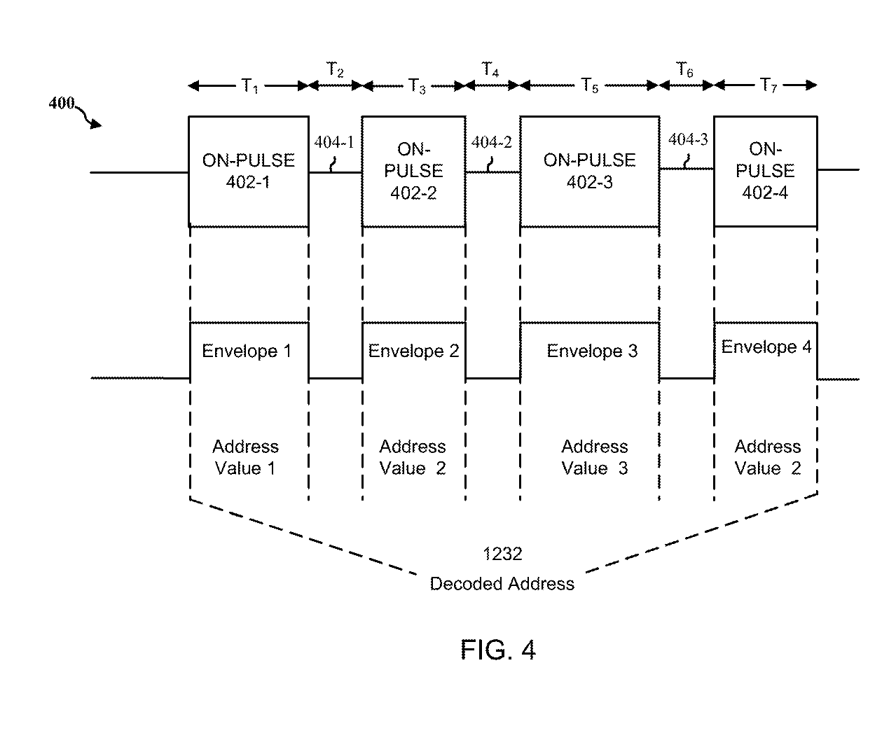

As an example, FIG. 4 illustrates a wake-up message with four packets of varying length that has been modulated with a carrier signal according to a modulation scheme that generates ON-pulses and OFF-pulses. The resulting wake-up message transmission 400 is shown, which includes a plurality of ON-pulses (402-1, 402-2, 402-3, and 402-4) and OFF-pulses (404-1, 404-2, and 404-3). Each ON-pulse of the plurality of ON-pulses has a corresponding pulse-width, which may be measured in time. Each Tx is a time period, where x is an integer. A time period may refer to a time value. For example, the first ON-pulse 402-1 may be T₁ in length, the second ON-pulse 402-2 may be T₃ in length, the third ON-pulse 402-3 may be T₅ in length, and the fourth ON-pulse 402-4 may be T₇ in length. Similarly, the first OFF-pulse 404-1 may be T₂ in length, the second OFF-pulse 404-2 may be T₄ in length, and the third OFF-pulse 404-3 may be T₆ in length. In some examples, T₂, T₄, and T₆ may be the same value (meaning that the length of each OFF-pulse 404-1 through 404-3 may be the same). In other examples, T₂, T₄, and T₆ may include one or more unequal values. The wake-up message from which the wake-up message transmission 400 was generated may be an example a wake-up message that was generated using a 2-bit encoding scheme. Because a 2-bit coding scheme was used and the plurality of ON-pulses is equal to four, the wake-up address is 8 bits in length in this particular example. In the example shown, the length of the first ON-pulse 402-1 is different from the length of ON-pulses 402-2, 402-3, and 402-4. The length of the second ON-pulse 402-2 and the fourth ON-pulse 402-4 are the same in this example, meaning that they represent the same bit value in different locations of the wake-up address corresponding to the wake-up message transmission. The third ON-pulse 402-3 is different from the length of ON-pulses 402-1, 402-2, and 402-4.

The sequence of the plurality of ON-pulses and OFF-pulses may be referred to as the wake-up message transmission 400. In some examples, the wake-up message transmission 400 may be referred to as a pulse-width modulation sequence. The first pulse 402-1 corresponds to a first packet and the length of the ON-pulse 402-1 corresponds to the length of the first packet of the wake-up message. The second pulse 402-2 corresponds to a second packet and the length of the ON-pulse 402-2 corresponds to the length of the second packet of the wake-up message. The third pulse 402-3 corresponds to a third packet and the length of the ON-pulse 402-3 corresponds to the length of the third packet of the wake-up message. The fourth pulse 402-4 corresponds to a fourth packet and the length of the ON-pulse 402-4 corresponds to the length of the fourth packet of the wake-up message. Each ON-pulse may have a respective envelope as shown. As described further below, the wake-up receiver 134 may include an envelope detector 137 configured to detect the envelope of a received signal. For example, in FIG. 4, the envelope detector 137 detects that the envelope of the wake-up message transmission 400 includes four envelopes: envelopes 1-4 that respectively correspond to each of the ON-pulses 402-1 through 402-4. The wake-up address detector 136 may be configured to convert each envelope corresponding to a packet into a respective address value. A respective value of an address may refer to a respective portion of the address. Each address value in combination may constitute a decoded address. For example, in FIG. 4, the decoded address may equal 1232. The address values 1, 2, and 3 may each correspond to a 2-bit value. For example, if address values 1, 2, and 3 respectively correspond to 00, 10, and 11; then the decoded address may equal 00101110.

Referring to FIGS. 2A-B, at block 220, the wake-up receiver 134 may be configured to receive information. In some examples, the received information may include a wake-up message shown by block 222. In such examples, the wake-up message transmitted at block 212 shown by block 214 may or may not be the received wake-up message shown by block 222. In other examples, the received information may include a non-wake-up message shown by block 224. In such examples, the non-wake-up message shown by block 224 may be transmitted by the primary device 102 or another device different from the secondary device 104. Block 218 shows an example of a non-wake-up message travelling or otherwise propagating to the secondary device 104.

At block 226, the wake-up receiver 134 may be configured to perform wake-up address detection. For example, the wake-up address detector 136 may be configured to determine whether received information is a wake-up message that includes a wake-up address associated with the secondary device 104 in which the wake-up receiver 134 resides. Based upon whether the received information is the requisite wake-up message, the wake-up address detector 136 may be configured to wake-up (e.g., activate) the main receiver 132 or not wake-up (e.g., not activate) the main receiver 132.

To perform wake-up address detection, the envelope detector 137 may be configured to perform envelope detection on received information at block 228. Received information may constitute any received transmission, such as a wake-up message shown at block 222 or a non-wake-up message (i.e., any transmission or signal that is not a wake-up message) shown at block 224. The envelope detector 137 may be configured to detect the envelope of received information (e.g., a received signal) and output or otherwise generate an envelope corresponding to the received information (e.g., the received signal).

At block 230, the wake-up address detector 136 may be configured to generate an address based on the envelope of the received information, such as in accordance with an N-bit decoding scheme. An address generated based on the envelope of received information may be referred to as a decoded address. In some examples, the term envelope may refer to the plurality of envelopes corresponding to a wake-up message. In other examples, the term envelope may refer to a single envelope of the plurality of envelopes corresponding to a wake-up message. To generate a decoded address, the wake-up address detector 136 may be configured to convert the envelope into a plurality of address values, where each address value in combination is the decoded address. For example, an envelope of received information may include a sequence of pulses, such as a plurality of ON-pulses and a plurality of OFF-pulses. In some examples, the wake-up address detector 136 may be configured to measure the time period of each envelope in the envelope of the received information. In such examples, the envelope detector 137 may be configured to measure the time period of each envelope. Each envelope may correspond to an ON-pulse of the received information.

To convert the envelope into a plurality of address values, the wake-up address detector 136 may be configured to compare a measured time period of an envelope to a data structure that maps a plurality of time periods to a plurality of address values and select the address value that corresponds to the time period that matches or is closest to the measured time period. Each time period of the plurality of time periods in the data structure may respectively correspond to one address value. The data structure may constitute a look-up table (LUT), where an input of a time period results in the output of an address value corresponding to the time period input. For example, to convert the envelope into a plurality of address values, the wake-up address detector 136 may be configured to input each time period corresponding to each ON-pulse into the data structure resulting in the output of an address value associated with each time period that was input into the data structure. Each address value in combination (e.g., when concatenated) may correspond to a wake-up address.

In some examples, an N-bit decoding data structure may be stored in a memory of the wake-up receiver 134 or a memory accessible by the wake-up receiver 134 (e.g., a memory of the secondary device 104). The plurality of time periods stored in the data structure in memory may also be referred to as packet length values, packet length time values, time periods, or the like. The plurality of address values stored in the data structure in memory may also be referred to as partial address values since alone each address value may constitute a portion of a wake-up address.

The portion of Table 3 below that maps time periods to address values (which may also be described as mapping address values to time periods) constitutes an example of a data structure stored in a memory of the wake-up receiver 134 or a memory accessible by the wake-up receiver 134. This data structure may be referred to as a decoding data structure. In the example of Table 3, the example decoding data structure is labeled as a 2-bit decoding data structure.

The portion of Table 4 below that maps time periods to address values (which may also be described as mapping address values to time periods) constitutes an example of a data structure stored in a memory of the wake-up receiver 134 or a memory accessible by the wake-up receiver 134. This data structure may be referred to as a decoding data structure. In the example of Table 4, the example decoding data structure is labeled as a 2-bit decoding data structure.

The portion of Table 5 below that maps time periods to address values (which may also be described as mapping address values to time periods) constitutes an example of a data structure stored in a memory of the wake-up receiver 134 or a memory accessible by the wake-up receiver 134. This data structure may be referred to as a decoding data structure. In the example of Table 5, the example decoding data structure is labeled as a 2-bit decoding data structure.

Table 6 below maps time periods to address values (which may also be described as mapping address values to time periods) constitutes an example of a data structure stored in a memory of the wake-up receiver 134 or a memory accessible by the wake-up receiver 134. This data structure may be referred to as a decoding data structure. In the example of Table 6, the example decoding data structure is labeled as a 3-bit decoding data structure.

As described herein, one or more wake-up addresses associated with the secondary device 104 may be stored in a memory of the wake-up receiver 134 or a memory accessible by the wake-up receiver 134 (e.g., a memory of the secondary device 104). As described herein, a wake-up address associated with the secondary device 104 may include a wake-up address corresponding to the wake-up receiver 134, a wake-up address corresponding to the main receiver 132, or a wake-up address corresponding to the secondary device 104. In some examples, two or more wake-up addresses may be associated with the secondary device 104. In such examples, the two or more wake-up addresses may be accessible by the wake-up receiver 134 for comparing any decoded address thereto. If a decoded address matches one of the two or more wake-up addresses, then the wake-up receiver 134 may be configured to activate the main receiver 132. Otherwise described, a wake-up receiver 134 may be configured to respond to one or more wake-up addresses. In some examples, a wake-up address may be unique. In other examples, a wake-up address may not be unique. In such examples, the wake-up address may be a group wake-up address associated with a plurality of devices.

In accordance with the N-bit decoding scheme (where N is a positive integer), 2^{N} represents the number of available time periods respectively corresponding to packet lengths (e.g., envelope lengths) that may be used to decode an envelope of a received wake-up message and N represents the number of bits each packet length may represent. Each time period is mapped to a corresponding N-bit value. As used herein, the term “time period” may be interchangeable with time value, time, or the like. In a 2-bit decoding scheme (i.e., where N=2), the number of available time periods that may be mapped to a 2-bit value is four. Similarly, in a 3-bit decoding scheme (i.e., where N=3), the number of available time periods that may be mapped to a 3-bit value is eight. As another example, in a 4-bit decoding scheme (i.e., where N=4), the number of available time periods that may be mapped to a 4-bit value is 16.

For example, in a 2-bit decoding scheme example, each of the first, second, third, and fourth time periods respectively corresponds to (e.g., is mapped to or otherwise associated with) one of the following 2-bit address values: 00, 01, 10, and 11. For example, the first time period may be mapped to 00, the second time period may be mapped to 01, the third time period may be mapped to 10, and the fourth time period may be mapped to 11.

In accordance with the N-bit decoding scheme, the time periods available for decoding an envelope of a received wake-up message may vary in length (e.g., vary in value) by a multiple of a packet length variance value, such as M time period (where M is any numerical value). Otherwise described, each time period may vary in length by M relative to at least one other time period. Each time period may correspond to an available packet length used in an N-bit encoding scheme. Therefore, a time period may also be referred to as a packet length. In one example, M may equal 40 (which may be any unit of time, such as microseconds, milliseconds, or seconds). In some examples, the packet length variance value M used in an N-bit encoding scheme (M_{ENCODING}) may be the same value of M used in the N-bit decoding scheme (M_{DECODING}) for decoding an envelope based off of a message encoded using the N-bit encoding scheme. For example, M_{ENCODING} may equal M_{DECODING}, but may have different units of measure (e.g., bits versus time). For example, M_{ENCODING} may equal 40 bits and M_{DECODING} may equal 40 microseconds. In other examples, M_{ENCODING} may be equal to P*M_{DECODING}, where P is any numerical value above 0 (e.g., 0.1, 0.5, 1, 1.5, 2, 10, or any other value). As an example, if M_{ENCODING} may equals 40 bits and M_{DECODING} equals 20 microseconds, then P=0.5 in this example. In some examples, P may be referred to as a bit-to-time unit conversion value. For example, if an X bit packet length, when modulated, as a packet length of X time periods, then P may equal 1. However, if an X bit packet length, when modulated, as a packet length of a time period different from X, then P may be less than or greater than 1. For example, if a packet length of 100 bits is a 60 microsecond envelope (e.g., a 60 microsecond ON-pulse), then P may equal 0.6.

In the example of M_{DECODING} equaling 40 microseconds, each time period may vary in length by 40 microseconds relative to at least one other packet, which is true for any value of M_{DECODING}. Similar to an N-bit encoding scheme, an even variance of M_{DECODING} may not occur. Instead, each time period may vary in length by at least one multiple of M_{DECODING} relative to at least one other time period. For example, as described above, 2^{N} represents the number of time periods that may be used to decode an envelope of a wake-up message and N represents the number of bits each time period may represent. If N=2 and the smallest time period of the four available time periods that may be used for decoding is T₁, then the additional time periods of the remaining three available packet lengths may include T₁+(M_{DECODING}), T₁+(2*M_{DECODING}), and T₁+(3*M_{DECODING}). In other examples, the additional time periods of the remaining three available time periods may include T₁+(M_{DECODING}*A), T₁+(M_{DECODING}*B), and T₁+(M_{DECODING}*C), where A<B<C and A, B, and C are each a positive integer. For example A may equal 1, B may equal 3, and C may equal 6. In this example, each time period of the four available time periods vary in length by at least one multiple of M_{DECODING} relative to at least one other time period. Since time period corresponds to packet length, the term time period may also be referred to as packet length in some examples.

As described herein, each time period may correspond to an available packet length used in an N-bit encoding scheme. For example, Table 3 below shows an example of an example 2-bit encoding scheme adjacent to a corresponding 2-bit decoding scheme as described herein.

TABLE 3

| | | | 2-Bit Decoding Data Structure | |
|---|---|---|---|---|
| | 2-Bit Encoding Data | | | Time Period |
| | Structure | | | (M_{DECODING} = Y * P), |
| | Packet Length | Address | Address | where P = a bit-to-time |
| Packet | (M_{ENCODING} = Y) | Value | Value | unit conversion value |
| 1 | X bits | 00 | 00 | T₁ = X * P |
| 2 | X + Y bits | 01 | 01 | T₂ = (X + Y) * P |
| 3 | X + (2 * Y) bits | 10 | 10 | T₃ = (X + (2 * Y)) * P |
| 4 | X + (3 * Y) bits | 11 | 11 | T₄ = (X + (3 * Y)) * P |

For example, where X=100, Y=30, and P=1, then Table 4 below shows such an example. A time unit may refer to a second, millisecond, microsecond, or the like. The example of Table 4 includes a time period-to-address value data structure associated with a 2-bit encoding scheme. For example to convert an envelope measured to be T₃ in length, the wake-up address detector 136 may be configured to compare T₃ to the mapping of time periods to address values, and select 10 as the address value for the envelope measured to be T₃ in length. As a more specific example, the envelope detector 137 may detect three sequential envelopes having measured lengths of T₄, T₁, and T₂. The wake-up address detector 136 may be configured to compare each of the measured time lengths to the mapping and generate a decoded address of 110001, provided that envelope corresponds to a wake-up message that is three packets in length.

TABLE 4

| | 2-Bit Encoding Data | | | |
|---|---|---|---|---|
| | Structure | | 2-Bit Decoding Data Structure | |
| | Packet Length | Address | Address | Time Period |
| Packet | (M_{ENCODING} = 30) | Value | Value | (M_{DECODING} = 30) |
| 1 | 100 bits | 00 | 00 | T₁ = 100 time units |
| 2 | 130 bits | 01 | 01 | T₂ = 130 time units |
| 3 | 160 bits | 10 | 10 | T₃ = 160 time units |
| 4 | 190 bits | 11 | 11 | T₄ = 190 time units |

As another example, where X=100, Y=30, and P=0.5, then Table 5 below shows such an example. The example of Table 5 includes a time period-to-address value data structure associated with a 2-bit encoding scheme. For example to convert an envelope measured to be T₁ in length, the wake-up address detector 136 may be configured to compare T₁ to the mapping of time periods to address values, and select 00 as the address value for the envelope measured to be T₁ in length.

TABLE 5

| | 2-Bit Encoding Data | | | |
|---|---|---|---|---|
| | Structure | | 2-Bit Decoding Data Structure | |
| | Packet Length | Address | Address | Time Period |
| Packet | (M_{ENCODING} = 30) | Value | Value | (M_{DECODING} = 15) |
| 1 | 100 bits | 00 | 00 | T₁ = 50 time units |
| 2 | 130 bits | 01 | 01 | T₂ = 65 time units |
| 3 | 160 bits | 10 | 10 | T₃ = 80 time units |
| 4 | 190 bits | 11 | 11 | T₄ = 95 time units |

Table 6 below illustrates an example data structure that maps a plurality of time periods to a plurality of address values. Each Tx is a time period, where xis an integer.

TABLE 6
3-Bit Decoding Data
Structure

| | Address |
|---|---|
| Time Period | Value |
| T₁ | 000 |
| T₂ | 001 |
| T₃ | 010 |
| T₄ | 100 |
| T₅ | 101 |
| T₆ | 110 |
| T₇ | 011 |
| T₈ | 111 |

The example of Table 6 corresponds to a time period-to-address value data structure associated with a 3-bit encoding scheme. For example to convert an envelope measured to be T₃ in length, the wake-up address detector 136 may be configured to compare T₃ to the mapping of time periods to address values, and select 010 as the address value for the envelope measured to be T₃ in length. As a more specific example, the envelope detector 137 may detect three sequential envelopes having measured lengths of T₄, T₁, and T₈. The wake-up address detector 136 may be configured to compare each of the measured time lengths to the mapping and generate a decoded address of 100000111, provided that envelope corresponds to a wake-up message that is three packets in length.

Referring back to FIGS. 2A-B, in some examples, at block 230, the wake-up address detector 136 may be configured to filter received information to determine whether the received information is a wake-up message or a non-wake-up message (e.g., any transmitted information that does not constitute a wake-up message). For example, the filter 139 of the wake-up receiver 134 may be configured to determine that received information does or does not constitute a wake-up message based on one or more criteria corresponding to the envelope of the received information. Otherwise described, the filter 139 may be configured to determine that received information constitutes a wake-up message when the received information satisfies each of the one or more criteria corresponding to the envelope of the received information.

If the wake-up address detector 136 determines at block 230 that the received information is not a wake-up message, the wake-up receiver 134 may be configured to not wake-up the main receiver 132, as shown by block 232. If the wake-up address detector 136 determines at block 230 that the received information is a wake-up message, the wake-up address detector 136 may be configured to generate a decoded address as described herein, and compare the decoded address to the address associated with the secondary device 104, which may be stored in a memory of the wake-up receiver 134 or a memory accessible by the wake-up receiver 134 (e.g., a memory of the secondary device 104). If the decoded address matches the wake-up address associated with the secondary device 104, the wake-up address detector 136 may be configured to wake-up (e.g., activate) the main receiver 132, as shown by blocks 230 and 234. If the decoded address does not match the wake-up address associated with the secondary device 104, the wake-up address detector 136 may be configured to not wake-up the main receiver 132 as shown by blocks 230 and 232.

In some examples, the wake-up address detector 136 may be configured to wake-up (e.g., activate) (e.g., wake-up) the main receiver 132 at block 234 by being configured to output an activation signal to the main receiver 132. Upon receiving the activation signal from the wake-up receiver 134, the main receiver 132 may be configured to enter an active mode during which the main receiver 132 may be configured to receive and process signals. For example, when awake (e.g., in an active mode), the main receiver may be configured to receive and process received signals; and, when asleep (e.g., in an inactive mode), the main receiver 132 may be configured to not process any signals received by any antenna communicatively coupled to the main receiver 132.

At block 236, the message generator 142 may be configured to generate a wake-up acknowledgement message as described herein. For example, the message generator 142 may be configured to generate a wake-up acknowledgement message to send to the primary device 102 from which the secondary device 104 received the wake-up message shown at block 214. For example, the message generator 142 may be configured to generate a wake-up acknowledgement message in response to a trigger event. In some examples, the trigger event may include a determination by the wake-up receiver 134 (e.g., by the wake-up address detector 136 of the wake-up receiver 134) that a decoded address associated with or otherwise corresponding to a received wake-up message matches the address associated with the secondary device 104. In other examples, the trigger event may include the output of an activation signal by the wake-up receiver 134 to the main receiver 132. In other examples, the trigger event may include the main receiver 132 entering an active state. The message generator 142 may be configured to send the generated wake-up acknowledgement message to the transmitter 138. At block 238, the transmitter 138 may be configured to transmit the generated wake-up acknowledgement message to the primary device 102 from which the secondary device 104 received the wake-up message that caused the main receiver 132 to be activated. Block 240 shows the wake-up acknowledgement message transmission.

At block 242, the receiver 122 may be configured to receive the wake-up acknowledgement message transmitted by the secondary device 104. In some examples, the primary device 102 may be configured to transmit, at block 244, one or more messages that include data to the secondary device 104 in response to reception of the wake-up acknowledgement message transmitted by the secondary device 104. The one or more messages that include data are not a wake-up message. Block 246 shows the transmission of one or more data messages. At block 248, the main receiver 132 of the secondary device 104 may be configured to, as a result of the activation by the wake-up receiver 134, receive and process the one or more data messages transmitted by the primary device 102.

Referring back to block 230, the one or more criteria corresponding to an envelope of received information may, in some examples, include at least one of: envelope length (e.g., the time period of an envelope), amplitude (e.g., presence or absence of amplitude modulation), frame time, inter-packet time (e.g., the length of OFF-pulses). The envelope length may correspond to packet length. Therefore, the envelope length may need correction or otherwise be fuzzy for variation that may be caused by low amplitude, timebase startup, and/or timebase error.

In some examples, a wake-up message may be compliant with a Bluetooth protocol. In such examples, the one or more filter criteria may be configured to discard various non-Bluetooth signals as well as Bluetooth signals that do not constitute a wake-up message. For example, at block 230, the filter 139 may be configured to determine that any signal different from a Bluetooth signal cannot be a wake-up message. For example, the filter 139 may be configured to determine, based on one or more criteria corresponding to an envelope of received information, whether the received information constitutes a signal that satisfies the one or more criteria checked by the filter 139. If the received signal does not satisfy the one or more criteria, the filter 139 may be configured to discard the received signal. If the received signal satisfies the one or more criteria, the wake-up address detector may be configured to generate a decoded address associated with the received signal in accordance with the techniques described herein.

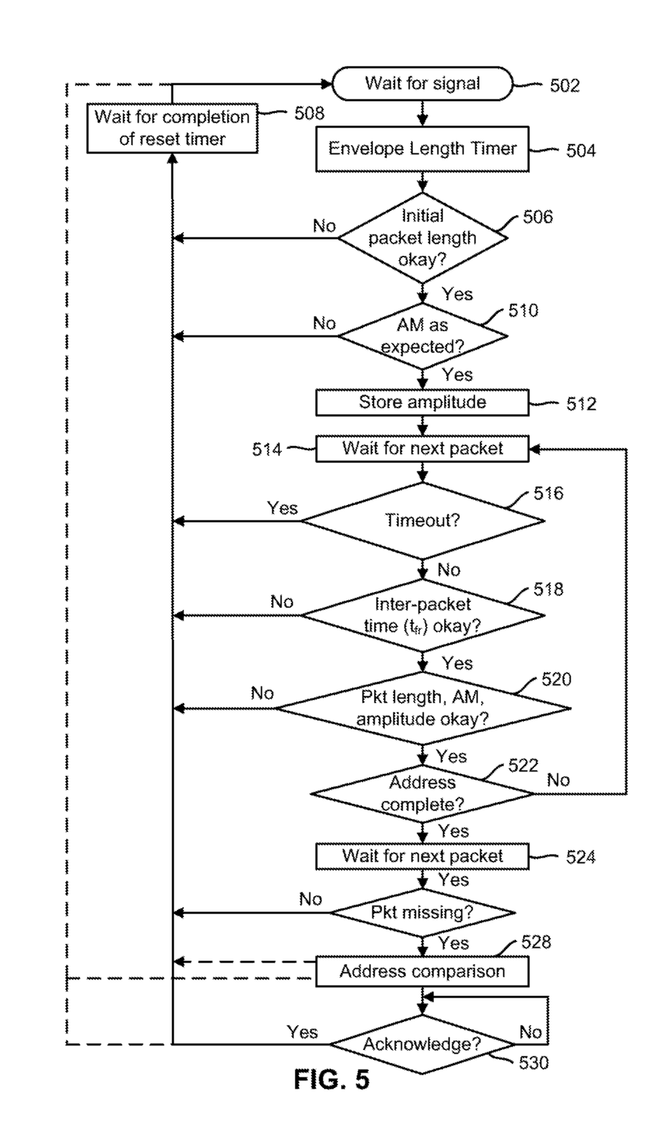

FIG. 5 illustrates one example of one or more criteria that the filter 139 and/or one or more other components of the wake-up receiver 134 may be configured to check against information received by the wake-up receiver 134 to determine that the received information is a wake-up message or not a wake-up message. At block 502, the wake-up receiver 134 may be configured to wait to receive a signal, such as a radio frequency signal. Once the wake-up receiver 134 detects the reception of a signal, the wake-up receiver 134 may be configured to start and read an envelope length timer at block 504 to measure the length of one or more envelopes of the received signal. For example, upon detecting the beginning of a first envelope (e.g., an ON-pulse), the wake-up receiver 134 may be configured to start an envelope length timer; and, upon detecting the end of the first envelope (e.g., the end of the ON-pulse and the beginning of an OFF-pulse), the wake-up receiver 134 may be configured to analyze whether the measured packet length (e.g., the measured time) corresponding to the first envelope meets a length criteria at block 506. At block 506, the wake-up receiver 134 may be configured to compare the measured packet length of the first envelope to a first threshold packet length value and/or a second threshold packet length value. In some examples, the first threshold packet length value may be a minimum threshold packet length value, and the second threshold packet length value may be a maximum threshold packet length value. As discussed in more detail below, the measurement of subsequent envelopes following the first envelope may also be measured by the envelope length timer. For example, the envelope length timer may be configured to measure the length of any ON-pulse and/or OFF-pulse of a received signal. In some examples, the envelope length timer may refer to an internal timebase or oscillator. The envelope length timer may initiate or otherwise upon receipt of any signal at block 502.

In some examples, if the wake-up receiver 134 determines that the measured packet length of the first envelope is less than the first threshold packet length value, then the wake-up receiver 134 may be configured to stop analysis of the received signal, read the envelope length timer, and initiate a reset timer at block 508. In such examples, the measured packet length of the first envelope being less than the first threshold packet length value may indicate that the received packet is too short in length relative to a packet of a wake-up message; and, therefore, the received information cannot constitute a wake-up message. Similarly, if the wake-up receiver 134 determines that the measured packet length of the first envelope is greater than the second threshold packet length value, then the wake-up receiver 134 may be configured to stop analysis of the received signal, read the envelope length timer, and initiate a reset timer at block 508. In such examples, the measured packet length of the first envelope being greater than the second threshold packet length value may indicate that the received packet is too long in length relative to a packet of a wake-up message; and, therefore, the received information cannot constitute a wake-up message.

The wake-up receiver 134 may be configured to do nothing until the completion of the reset timer at block 508. In some examples, the length of the reset timer to complete may be less than, equal to, or greater than 200 microseconds. In some examples, the reset timer is an analog circuit with one or more capacitors. For example, the length of the reset timer to complete may be measured by one or more capacitors discharging to a certain threshold. Once the capacitors discharge to a threshold voltage (e.g., zero volts or a different threshold voltage), the reset timer may be described as being complete. Before completion of the reset timer, the wake-up receiver 134 may receive a signal. However, the wake-up receiver 134 may be configured to not initiate the envelope length timer at block 504 or initiate any other hardware component of the wake-up receiver 134 because the reset timer has yet to complete (e.g., reach a certain value, such as 0 if counting down from a value). In some examples, each block shown in FIG. 5 may constitute a hardware component or circuitry of the wake-up receiver 134. Implementation of the reset timer may enable the wake-up receiver 134 to avoid analyzing subsequent packets in the same signal as a packet in that signal that was deemed to not meet one or more criteria. In some examples, the wake-up receiver 134 may be configured to re-initiate the reset timer upon detection of a signal before completion of the reset timer. In such examples, by re-initiating (e.g., restarting) the reset timer in such a manner, analysis of signals that do not constitute a wake-up message may be reduced.

If the wake-up receiver 134 determines that the measured packet length of the first envelope is equal to or greater than the first threshold packet length value and is equal to or less than the second threshold packet length value, the wake-up receiver 134 may be configured to continue analysis of the received signal by determining whether the received signal includes amplitude modulation (AM) as expected at block 510. For example, the wake-up receiver may be configured to determine whether the first envelope is indicative of whether the portion of the signal corresponding to the first envelope includes or excludes AM. In some examples, the expected AM is no presence of AM, meaning that a signal corresponding to a wake-up message does not include AM. In such examples, if the wake-up receiver 134 determines that the first envelope is indicative that the received signal includes AM, the wake-up receiver 134 may be configured to stop analysis of the received signal, read the envelope length timer, and initiate a reset timer at block 508. If the wake-up receiver 134 determines that the first envelope is indicative that the received signal does not include AM, the wake-up receiver 134 may be configured to continue analysis of the received signal by storing an amplitude corresponding to the first envelope at block 512. In other examples, the expected AM is the presence of AM, meaning that a signal corresponding to a wake-up message include AM. In such examples, if the wake-up receiver 134 determines that the first envelope is indicative that the received signal does not include AM, the wake-up receiver 134 may be configured to stop analysis of the received signal, read the envelope length timer, and initiate a reset timer at block 508. If the wake-up receiver 134 determines that the first envelope is indicative that the received signal includes AM, the wake-up receiver 134 may be configured to continue analysis of the received signal by storing an amplitude corresponding to the first envelope at block 512. In other examples, the wake-up receiver 134 may be configured to not determine whether the received signal includes amplitude modulation (AM). In such examples, blocks 510 and 512 may not be present. Instead, block 506 may proceed directly to block 514. Similarly, block 520, described below, may be configured to not determine whether the received signal includes AM. In such examples, blocks 520 may be configured to only check packet length instead of packet length and the presence of AM.

At block 514, the wake-up receiver 134 may be configured to wait for reception of the next packet of the signal (e.g., wait for reception of the next ON-pulse of the signal). The wake-up receiver 134 may be configured to measure the time from the end of the first envelope (e.g., the start of an OFF-pulse) to the beginning of the next packet (e.g., the end of the OFF-pulse) while waiting to receive the next packet to make the determinations associated with blocks 516 and 518. In some examples, the time may be measured using the envelope length timer initiated at block 504. For example, the packet length of the first envelope may correspond to the difference between a first time (which corresponds to the beginning of the envelope) and a second time (which corresponds to the end of the envelope). The subsequent OFF-pulse may correspond to the difference between the second time and a third time (which corresponds to the beginning of the next envelope of the next ON-pulse).

At block 516, the wake-up receiver 134 may be configured to determine whether the OFF-pulse following an ON-pulse of the signal is too long. For example, if the wake-up receiver 134 determines that the OFF-pulse following an ON-pulse is greater than a first threshold inter-packet time value, the wake-up receiver 134 may be configured to stop analysis of the received signal, read the envelope length timer, and initiate a reset timer at block 508. In some examples, the wake-up receiver 134 may be configured to determine that the OFF-pulse following an ON-pulse is too long without receiving a subsequent ON-pulse by measuring the time from the start of the OFF-pulse. In some examples, the wake-up receiver 134 may receive an ON-pulse following an OFF-pulse before timing out at block 516. In such examples, the wake-up receiver may be configured to continue analysis because the OFF-pulse is less than the first threshold inter-packet time value.

At block 518, the wake-up receiver 134 may be configured to determine whether the OFF-pulse following an ON-pulse of the signal is too short. For example, if the wake-up receiver 134 determines that the OFF-pulse following an ON-pulse is less than a second threshold inter-packet time value, the wake-up receiver 134 may be configured to stop analysis of the received signal, read the envelope length timer, and initiate a reset timer at block 508. In some examples, the first threshold inter-packet time value is a maximum threshold inter-packet time value, and the second threshold inter-packet time value is a minimum threshold inter-packet time value. As used herein, the term inter-packet time value may refer to an OFF-pulse time value. If the wake-up receiver 134 determines that the OFF-pulse following an ON-pulse is equal to greater than a second threshold inter-packet time value, the wake-up receiver 134 may be configured to continue analysis by determining whether the ON-pulse following the OFF-pulse determined to satisfy an inter-packet length criteria being analyzed satisfies at least one of: (1) the packet length criteria described with respect to block 506 but performed at block 520, (2) the expected AM criteria described with respect to block 510 but performed at block 520, or (3) an amplitude criteria. Pursuant to the amplitude criteria, the wake-up receiver 134 may be configured to determine whether each packet (excluding the first packet) has the same amplitude compared to the previous packet. At block 520 and in the same manner as described with respect to block 506, the wake-up receiver 134 may be configured to determine whether the measured packet length of the each respective ON-pulse following the first ON-pulse in a signal envelope is equal to or greater than the first threshold packet length value and is equal to or less than the second threshold packet length value. If an ON-pulse of the signal does not satisfy this packet length criteria, then the wake-up receiver 134 may be configured to stop analysis of the received signal, read the envelope length timer, and initiate a reset timer at block 508. If an ON-pulse of the signal does satisfy this packet length criteria, then the wake-up receiver 134 may be configured to determine whether the ON-pulse includes amplitude modulation (AM) as expected in the same manner as described with respect to block 510.

If an ON-pulse of the signal does not satisfy this expected AM criteria, then the wake-up receiver 134 may be configured to stop analysis of the received signal, read the envelope length timer, and initiate a reset timer at block 508. If an ON-pulse of the signal does satisfy this expected AM criteria, then the wake-up receiver 134 may be configured to continue analysis by determining whether the decoded address that the wake-up receiver 134 is generating a packet at a time is complete at block 522. For example, as each packet comes in that satisfies the filter criteria, the wake-up receiver may be configured to convert the packet length into an address value corresponding to a wake-up address.

The wake-up receiver 134 may be configured to determine whether the wake-up address is complete by comparing the bit-length of the decoded address to the bit-length of a wake-up address. If a match, then the decoded address is complete. If not a match (e.g., if the bit length of the decoded address is less than the bit-length of a wake-up address), then the wake-up receiver 134 may be configured to return to block 514 to continue analyzing any received packets in the manner described above. Once the wake-up receiver 134 determines that the decoded address is complete at block 522, the wake-up receiver 134 may be configured to proceed to block 524. At block 524, the wake-up receiver 134 may be configured to wait for reception of another packet of the signal (e.g., wait for reception of another ON-pulse of the signal). At block 526, the wake-up receiver 134 may be configured to measure the time from the end of the last packet corresponding to the last value of the decoded address while waiting to see if another packet is received. Once this time measurement at block 526 reaches a threshold packet missing time value, the wake-up receiver 134 may be configured to proceed to block 528. However, if the wake-up receiver 134 receives a packet before the time measurement initiated at block 526 reaches the threshold packet missing time value, then the wake-up receiver 134 may be configured to stop analysis of the received signal, read the envelope length timer, and initiate a reset timer at block 508. In some examples, the threshold packet missing time value may prevent the initial bits of a longer address falsely triggering a shorter address match. Therefore, the threshold packet missing time value may also be referred to as an end of message threshold time value.

At block 528, the wake-up receiver 134 may be configured to compare the decoded address to the wake-up address associated with the secondary device 104. If the decoded address matches the wake-up address associated with the secondary device 104, the wake-up receiver 134 may be configured to wake-up the main receiver 132 and proceed to block 530. In some examples, to wake-up the main receiver 132, the wake-up receiver 134 may be configured to output an activation signal on a first conductive path that communicatively couples the wake-up receiver 134 with the main receiver 132. For example, the activation signal may be a voltage signal output on the first conductive path. If the decoded address does not match the wake-up address associated with the secondary device 104, the wake-up receiver 134 may be configured to not wake-up the main receiver 132. If the decoded address does not match, the wake-up receiver 134 may be configured to proceed to block 508 or block 502.

At block 530, the wake-up receiver 134 may be configured to wait for receipt of an acknowledgement signal from the main receiver 132 indicating that the main receiver 132 has awoken or otherwise become active in response to the activation signal. In such examples, the main receiver 132 may be configured to output an acknowledgement signal on a second conductive path that communicatively couples the wake-up receiver 134 with the main receiver 132. For example, the acknowledgement signal may be a voltage signal output on the second conductive path. Once the wake-up receiver 134 receives an acknowledgement signal from the main receiver 132, the wake-up receiver 134 may be configured to proceed to block 508 or block 502. In some examples, if the wake-up receiver 134 does not receive an acknowledgement signal from the main receiver 132 after a period of time elapses, the wake-up receiver 134 may be configured to output the activation signal. In such examples, the period of time may be measured from when the activation signal was output by the wake-up receiver 134. In other examples, if the wake-up receiver 134 does receive an acknowledgement signal from the main receiver 132 before a period of time elapses, the wake-up receiver 134 may be configured to proceed to block 508 or block 502. In such examples, the period of time may be measured from when the activation signal was output by the wake-up receiver 134.

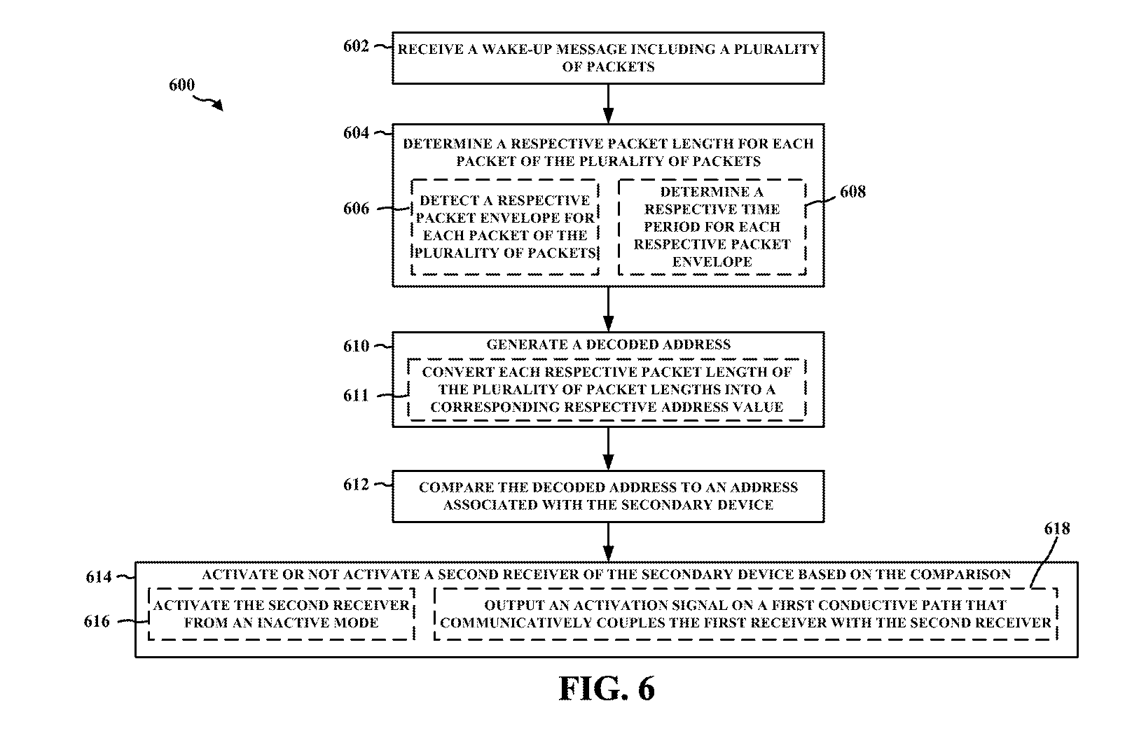

FIG. 6 is a flowchart 600 of a method in accordance with one or more techniques of this disclosure. The method may be performed by a first receiver (e.g., a wake-up receiver) of a secondary device (e.g., secondary device 104, apparatus 804, apparatus 904′, or another device, apparatus or secondary device described herein). In some examples, the method illustrated in flowchart 600 may include one or more function described herein (e.g., one or more functions described with respect to FIGS. 1-5) that are not illustrated in FIG. 6, and/or may exclude one or more illustrated functions.

At block 602, the first receiver may be configured to receive a wake-up message including a plurality of packets. In some examples, the wake-up message may be a signal that includes a sequence of ON-pulses and OFF-pulses. In such examples, each respective OFF-pulse of the OFF-pulses may have a respective amplitude less than a respective amplitude of each respective ON-pulse of the ON-pulses. Each respective packet of the plurality of packets may correspond to a respective ON-pulse of the signal. In some examples, each respective OFF-pulse may be positioned between two respective ON-pulses.

At block 604, the first receiver may be configured to determine a respective packet length for each packet of the plurality of packets. Each respective packet may vary in packet length relative to at least one other respective packet of the plurality of packets by a respective multiple of a packet length variance value. In some examples, to determine the respective packet length for each packet of the plurality of packets, the first receiver may be configured to detect a respective packet envelope for each packet of the plurality of packets at block 606, and determine a respective time period for each respective packet envelope at block 608. In such examples, the determined respective time period corresponds to the respective packet length. In such examples, the wake-up message may be a signal that includes a sequence of ON-pulses and OFF-pulses. Each respective packet envelope may be a respective ON-pulse of the ON-pulses. Each respective OFF-pulse of the OFF-pulses may be positioned between two respective ON-pulses of the ON-pulses.

At block 610, the first receiver may be configured to generate a decoded address. For example, to generate the decoded address, the first receiver may be configured to convert each respective packet length of the plurality of packet lengths into a corresponding respective address value at block 611. Each respective address value in combination may constitute the decoded address. At block 612, the first receiver may be configured to compare the decoded address to an address associated with the secondary device. In some examples, the address associated with the secondary device may include a wake-up address corresponding to the first receiver. In other examples, the address associated with the secondary device may include a wake-up address corresponding to a second receiver of the secondary device communicatively coupled to the first receiver. The second receiver may be a main receiver and the first receiver may be a wake-up receiver. In other examples, the address associated with the secondary device may include a wake-up address corresponding to the secondary device.

At block 614, the first receiver may be configured to activate or not activate a second receiver of the secondary device based on the comparison. The second receiver may be a main receiver and the first receiver may be a wake-up receiver. The first receiver may be configured to activate the second receiver when the decoded address matches the address associated with the secondary device. The first receiver may be configured to not activate the second receiver when the decoded address does not match the address associated with the secondary device. In some examples, to activate the second receiver, the first receiver may be configured to activate the second receiver from an inactive mode at block 616. In some examples, to activate the second receiver, the first receiver may be configured to output an activation signal on a first conductive path that communicatively couples the first receiver with the second receiver at block 618. For example, the activation signal may be a voltage signal output on the conductive path.

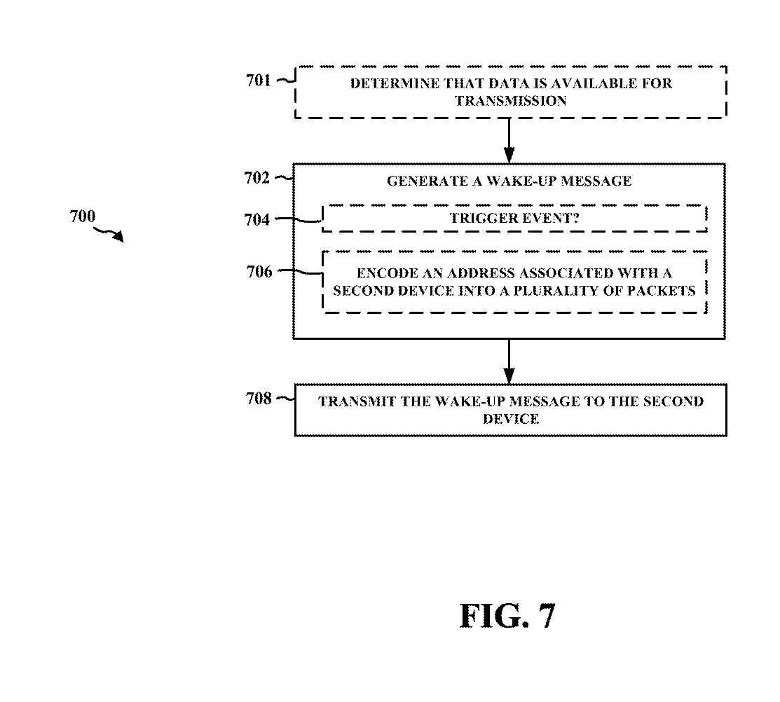

FIG. 7 is a flowchart 700 of a method in accordance with one or more techniques of this disclosure. The method may be performed by a primary device (e.g., primary device 102, apparatus 1002, apparatus 1102′, or another device, apparatus or primary device described herein). In some examples, the method illustrated in flowchart 700 may include one or more function described herein (e.g., one or more functions described with respect to FIGS. 1-5) that are not illustrated in FIG. 7, and/or may exclude one or more illustrated functions.

At block 702, the primary device may be configured to generate a wake-up message. In some examples, to generate the wake-up message, the primary device is configured to generate the wake-up message in response to a trigger event as shown at block 704. In some examples, to generate the wake-up message, the primary device may be configured to encode an address associated with the second device into a plurality of packets at block 706. The length of each packet of the plurality of packets in combination may be representative of the address. In some examples, at least two packets of the plurality of packets may vary in packet length by a multiple of a packet length variance value. The wake-up message may include the plurality of packets.

In some examples, the address is a plurality of bits. In such examples, each respective packet length of the plurality of packets may correspond to N bits of the plurality of bits, where N is an integer greater than or equal to 2. In such examples, each respective packet length may be greater than the N bits to which the respective packet length corresponds.

At block 708, the primary device may be configured to transmit the wake-up message to a second device.

In some examples, the primary device may be configured to determine that data is available for transmission to the second device at block 701. In such examples, the trigger event may include the determination that data is available for transmission to the second device.

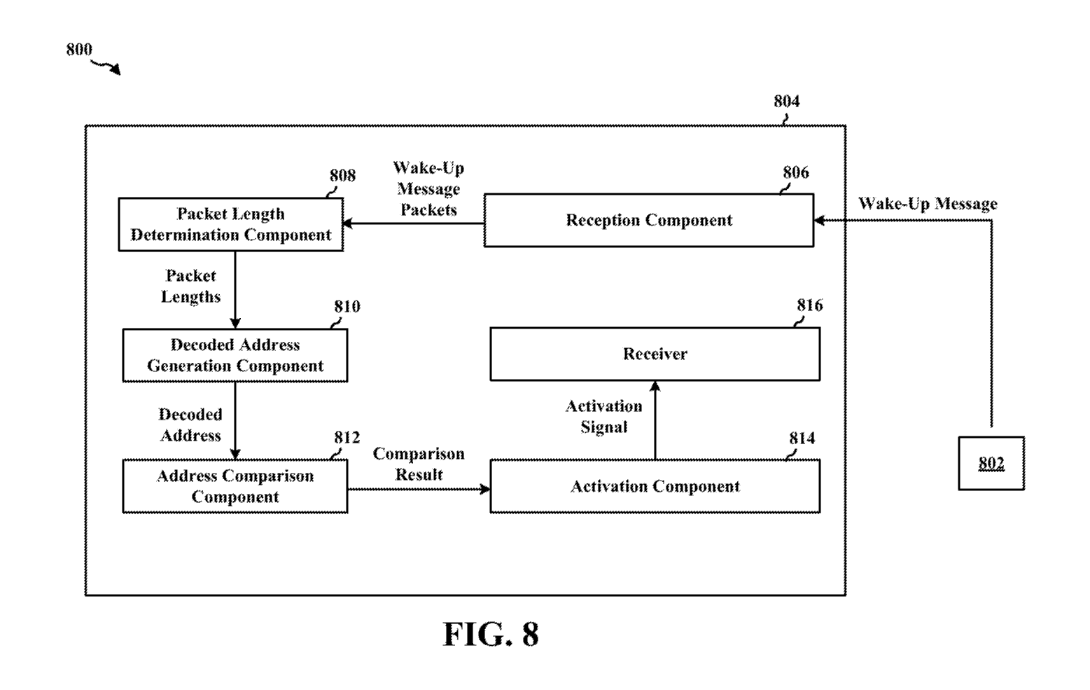

FIG. 8 is a conceptual data flow diagram 800 illustrating an example data flow between different means/components in apparatus 804. The apparatus 804 may be a secondary device. For example, the apparatus 804 may be any secondary device configured to perform one or more techniques described herein. For example, the apparatus 804 may be any secondary device described herein, such as secondary device 104, or any other secondary device configured to perform one or more techniques described herein. As an example, the apparatus 804 may be configured to perform any function described with respect to secondary device 104.

The apparatus 804 may include a reception component 806, a packet length determination component 808, a decoded address generation component 810, an address comparison component 812, an activation component 814, and a receiver 816.

The reception component 806 may be configured to receive a wake-up message including a plurality of packets. For example, the reception component 806 may be configured to receive a wake-up message including a plurality of packets from a primary device 802. The packet length determination component 808 may be configured to receive the plurality of packets corresponding to the wake-up message from the reception component. The packet length determination component 808 may be configured to determine a respective packet length for each packet of the plurality of packets. In some examples, to determine the respective packet length for each packet of the plurality of packets, the packet length determination component 808 may be configured to detect a respective packet envelope for each packet of the plurality of packets, and determine a respective time period for each respective packet envelope.

The decoded address generation component 810 may be configured to receive each packet length determined by the packet length determination component 808. The decoded address generation component 810 may be configured to generate a decoded address. For example, to generate the decoded address, the decoded address generation component 810 may be configured to convert each respective packet length of the plurality of packet lengths into a corresponding respective address value. Each respective address value in combination may constitute the decoded address.

The address comparison component 812 may be configured to receive the decoded address generated by the decoded address generation component 810. The address comparison component 812 may be configured to compare the decoded address to an address associated with the apparatus 804. The activation component 814 may be configured to receive a comparison result from the address comparison component 812. The activation component 814 may be configured to activate or not activate a receiver 816 of the apparatus based on the comparison result. In some examples, the activation component 814 may be configured to activate the receiver 816 when the comparison result is indicative that the decoded address matches the address associated with the apparatus 804. In some examples, the activation component 814 may be configured to not activate the receiver 816 when the comparison result is indicative that the decoded address does not match the address associated with the apparatus 804. In some examples, to activate the receiver 816, the activation component 814 may be configured to output an activation signal on a first conductive path that communicatively couples the receiver 816 with the activation component 814.

The apparatus 804 may include additional components that perform one or more secondary device functions described with respect to FIGS. 1-7. As such, each secondary device function described with respect to FIGS. 1-7 may be performed by a component and the apparatus 804 may include one or more of those components. The components may be one or more hardware components specifically configured to carry out the stated processes/algorithm, implemented by a processor, wake-up receiver, main receiver, and/or transmitter configured to perform the stated processes/algorithm, stored within a computer-readable medium for implementation by a processor, or some combination thereof.

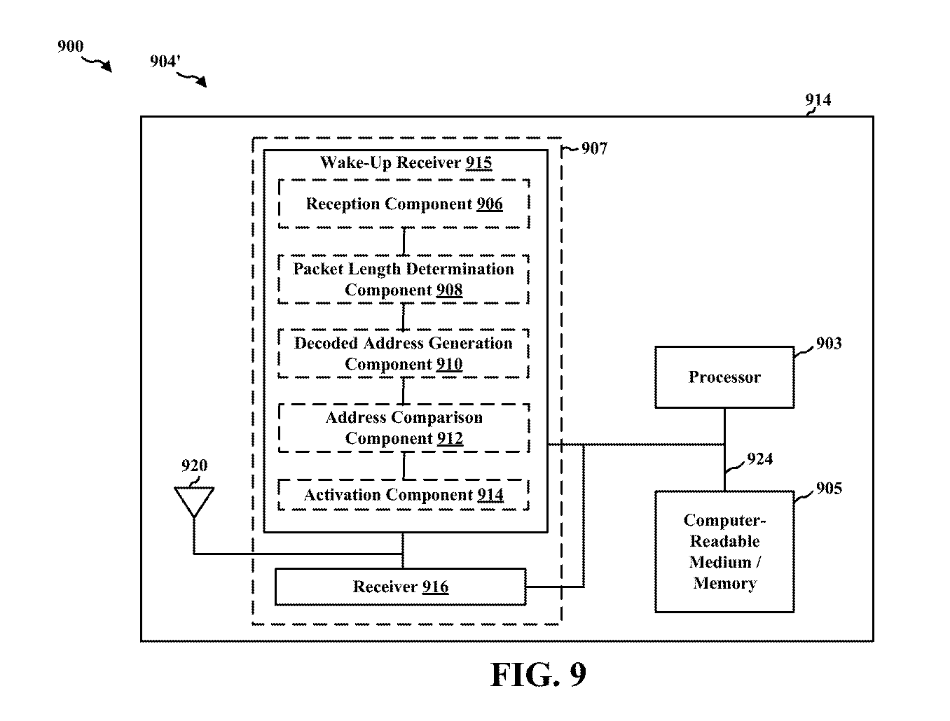

FIG. 9 is a diagram 900 illustrating an example of a hardware implementation for an apparatus 904′ employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 may link together various circuits including one or more processors and/or hardware components, represented by the processor 903, the computer-readable medium/memory 905, the wake-up receiver 915, and the receiver 916. The bus 924 may also link various other circuits such as timing sources, peripherals, voltage regulators, and power management circuits, which are well known in the art, and therefore, will not be described any further.

The wake-up receiver 915 and the receiver 916 may be combined into a transceiver 907. The wake-up receiver 915 and the receiver 916 may be coupled to one or more antennas 920. The wake-up receiver 915 may receive a signal from the one or more antennas 920 and perform processing on the received signal using one or more components of the wake-up receiver 915, such as the reception component 906, the packet length determination component 908, the decoded address generation component 910, the address comparison component 912, and/or the activation component 914. Any component of the wake-up receiver 915 may be a software component running in the wake-up receiver 915, resident/stored in the computer readable medium/memory 905, one or more hardware components coupled to the wake-up receiver 915, or some combination thereof. The processing system 914 includes a processor 903 coupled to a computer-readable medium/memory 905. The processor 903 is responsible for general processing, including the execution of software stored on the computer-readable medium/memory 905. The software, when executed by the processor 903, causes the processing system 914 to perform the various functions described herein for any particular apparatus. The computer-readable medium/memory 905 may also be used for storing data that is manipulated by the processor 903 when executing software. The processing system 914 may further include, for example, a message generator component. The message generator component may be a software component running in the processor 903, resident/stored in the computer readable medium/memory 905, one or more hardware components coupled to the processor 903, or some combination thereof.

The processing system 914 may be a component of any secondary device described herein (e.g., secondary device 104, apparatus 804, or any other secondary device configured to perform one or more techniques described herein. The aforementioned components of the apparatus 804 and/or the processing system 914 of the apparatus 904′ may each be a means for performing the one or more functions respectively corresponding to each of the aforementioned components. In some examples, the reception component 906, packet length determination component 908, decoded address generation component 910, address comparison component 912, activation component 914, and receiver 916 may respective correspond to the reception component 806, packet length determination component 808, decoded address generation component 810, address comparison component 812, activation component 814, and receiver 816. Similarly, the wake-up receiver 915, the receiver 916, and the one or more antennas 920 may respectively correspond to the wake-up receiver 134, the main receiver 132, and the one or more antennas 141 of a secondary device 104.

The aforementioned components of the apparatus 804 and/or the processing system 914 of the apparatus 904′ may each be a means for performing the one or more functions respectively corresponding to each of the aforementioned components.

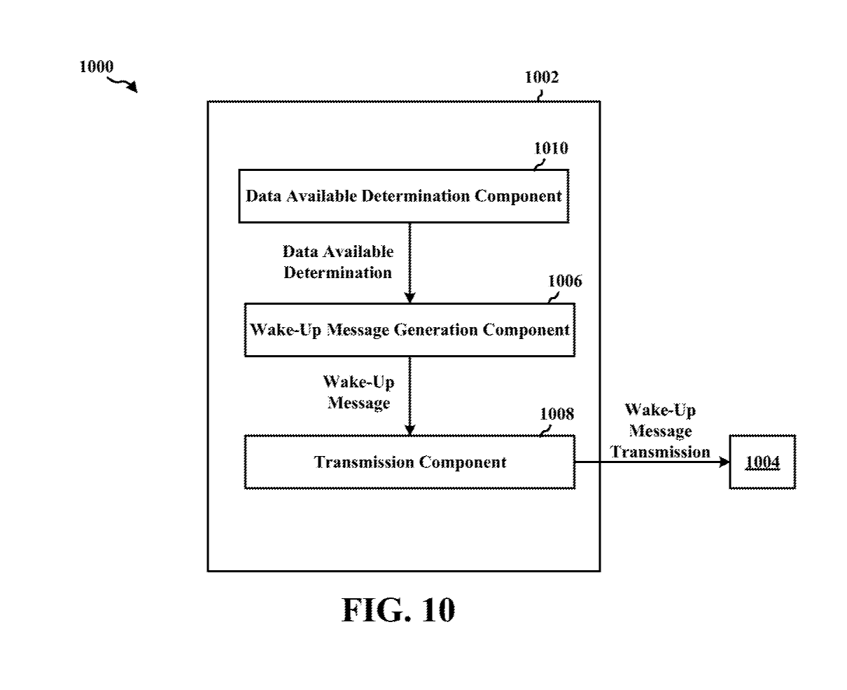

FIG. 10 is a conceptual data flow diagram 1000 illustrating an example data flow between different means/components in apparatus 1002. The apparatus 1002 may be a primary device. For example, the apparatus 1002 may be any primary device configured to perform one or more techniques described herein. For example, the apparatus 1002 may be any primary device described herein, such as primary device 102, or any other primary device configured to perform one or more techniques described herein. As an example, the apparatus 1002 may be configured to perform any function described with respect to primary device 102.

The apparatus 1002 may include a wake-up message generation component 1006, a packet length determination component 808, a decoded address generation component 810, an address comparison component 812, and an activation component 814.

The wake-up message generation component 1006 may be configured to generate a wake-up message. In some examples, to generate the wake-up message, the wake-up message generation component is configured to generate the wake-up message in response to a trigger event. In some examples, to generate the wake-up message, the wake-up message generation component 1006 may be configured to encode an address associated with the apparatus 1002 into a plurality of packets. The generated wake-up message may include the plurality of packets. The transmission component 1008 may be configured to receive the generated wake-up message from the wake-up message generation component 1006. The transmission component 1008 may be configured to transmit the wake-up message to a second device 1004.

In some examples, the data available determination component 1010 may be configured to determine that data is available for transmission to the second device 1004. In such examples, the trigger event may include the determination that data is available for transmission to the second device 1004.

The apparatus 1002 may include additional components that perform one or more secondary device functions described with respect to FIGS. 1-7. As such, each primary device function described with respect to FIGS. 1-7 may be performed by a component and the apparatus 1002 may include one or more of those components. The components may be one or more hardware components specifically configured to carry out the stated processes/algorithm, implemented by a processor, receiver, and/or transmitter configured to perform the stated processes/algorithm, stored within a computer-readable medium for implementation by a processor, or some combination thereof.

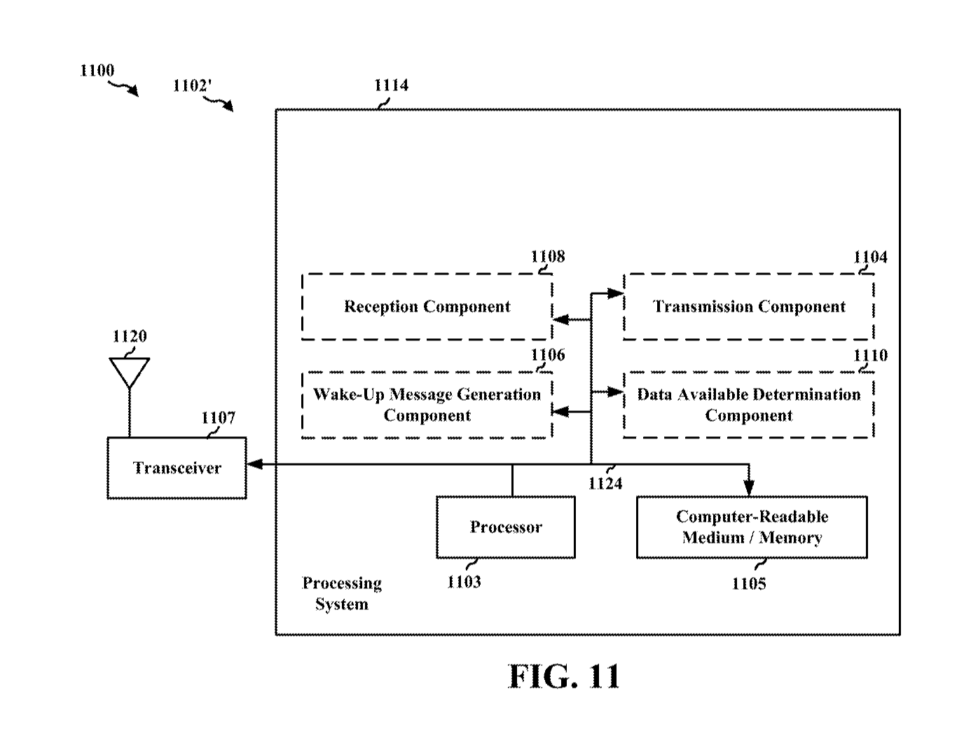

FIG. 11 is a diagram 1100 illustrating an example of a hardware implementation for an apparatus 1102′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 may link together various circuits including one or more processors and/or hardware components, represented by the processor 1103, the transmission component 1104, the reception component 1108, the wake-up message generation component 1106, the data available determination component 1110, and the computer-readable medium/memory 1105. The bus 1124 may also link various other circuits such as timing sources, peripherals, voltage regulators, and power management circuits, which are well known in the art, and therefore, will not be described any further.

The processing system 1114 may be coupled to a transceiver 1107. The transceiver 1107 is coupled to one or more antennas 1120. The transceiver 1107 provides a means for communicating with various other apparatus over a transmission medium. The transceiver 1107 receives a signal from the one or more antennas 1120, extracts information from the received signal, and provides the extracted information to the processing system 1114, specifically the reception component 1108. In addition, the transceiver 1107 receives information from the processing system 1114, specifically the transmission component 1104, and based on the received information, generates a signal to be applied to the one or more antennas 1120. The processing system 1114 includes a processor 1103 coupled to a computer-readable medium/memory 1105. The processor 1103 is responsible for general processing, including the execution of software stored on the computer-readable medium/memory 1105. The software, when executed by the processor 1103, causes the processing system 1114 to perform the various functions described herein for any particular apparatus. The computer-readable medium/memory 1105 may also be used for storing data that is manipulated by the processor 1103 when executing software. The processing system 1114 further includes at least one or more of the following components: the wake-up message generation component or the data available determination component 1110. The components may be software components running in the processor 1103, resident/stored in the computer readable medium/memory 1105, one or more hardware components coupled to the processor 1103, or some combination thereof.

The processing system 1114 may be a component of any primary device described herein (e.g., primary device 102, apparatus 1002, or any other primary device configured to perform one or more techniques described herein. The aforementioned components of the apparatus 1002 and/or the processing system 1114 of the apparatus 1102′ may each be a means for performing the one or more functions respectively corresponding to each of the aforementioned components. The aforementioned components of the apparatus 1002 and/or the processing system 1114 of the apparatus 1102′ may each be a means for performing the one or more functions respectively corresponding to each of the aforementioned components.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method comprising:
receiving, by a first receiver of a device, a wake-up message, wherein the wake-up message includes a plurality of packets;
determining, by the first receiver, a respective packet length for each packet of the plurality of packets, wherein each respective packet varies in packet length relative to at least one other respective packet of the plurality of packets by a respective multiple of a packet length variance value;
generating, by the first receiver, a decoded address by converting each respective packet length of the plurality of packet lengths into a corresponding respective address value, wherein each respective address value in combination is the decoded address;
comparing, by the first receiver, the decoded address to an address associated with the device; and
activating or not activating, by the first receiver, a second receiver of the device based on the comparison, wherein activating the second receiver occurs when the decoded address matches the address associated with the device, and wherein not activating the second receiver occurs when the decoded address does not match the address associated with the device.

2. The method of claim 1, wherein the wake-up message is a signal that includes a sequence of ON-pulses and OFF-pulses.

3. The method of claim 2, wherein each of the OFF-pulses has a respective amplitude less than a respective amplitude of each of the ON-pulses.

4. The method of claim 2, wherein each respective packet of the plurality of packets corresponds to a respective ON-pulse of the signal.

5. The method of claim 4, wherein each respective OFF-pulse is positioned between two respective ON-pulses.

6. The method of claim 1, wherein determining the respective packet length for each packet of the plurality of packets includes:
detecting a respective packet envelope for each packet of the plurality of packets; and
determining a respective time period for each respective packet envelope, wherein the determined respective time period corresponds to the respective packet length.

7. The method of claim 6, wherein the wake-up message is a signal that includes a sequence of ON-pulses and OFF-pulses, and wherein each respective packet envelope is a respective ON-pulse of the ON-pulses, and wherein each respective OFF-pulse of the OFF-pulses is positioned between two respective ON-pulses of the ON-pulses.

8. The method of claim 1, wherein activating the second receiver by the first receiver includes activating the second receiver from an inactive mode.

9. The method of claim 1, wherein activating the second receiver by the first receiver includes:
outputting, by the first receiver, an activation signal on a first conductive path that communicatively couples the first and second receivers.

10. A device comprising:
at least one antenna;
a first receiver communicatively coupled to the at least one antenna; and
a second receiver communicatively coupled to the first receiver, wherein the first receiver is configured to:
receive a wake-up message from the at least one antenna, wherein the wake-up message includes a plurality of packets;
determine a respective packet length for each packet of the plurality of packets, wherein each respective packet varies in packet length relative to at least one other respective packet of the plurality of packets by a respective multiple of a packet length variance value;
generate a decoded address by being configured to convert each respective packet length of the plurality of packet lengths into a corresponding respective address value, wherein each respective address value in combination is the decoded address;
compare the decoded address to an address associated with the device; and
activate or not activate the second receiver based on the comparison, wherein the first receiver is configured to activate the second receiver when the decoded address matches the address associated with the device, and wherein the first receiver is configured to not activate the second receiver when the decoded address does not match the address associated with the device.

11. The device of claim 10, wherein the wake-up message is a signal that includes a sequence of ON-pulses and OFF-pulses.

12. The device of claim 11, wherein each of the OFF-pulses has a respective amplitude less than a respective amplitude of each of the ON-pulses.

13. The device of claim 11, wherein each respective packet of the plurality of packets corresponds to a respective ON-pulse of the signal.

14. The device of claim 13, wherein each respective OFF-pulse is positioned between two respective ON-pulses.

15. The device of claim 10, wherein to determine the respective packet length for each packet of the plurality of packets, the first receiver is configured to:
detect a respective packet envelope for each packet of the plurality of packets; and
determine a respective time period for each respective packet envelope, wherein the determined respective time period corresponds to the respective packet length.

16. The device of claim 15, wherein the wake-up message is a signal that includes a sequence of ON-pulses and OFF-pulses, and wherein each respective packet envelope is a respective ON-pulse of the ON-pulses, and wherein each respective OFF-pulse of the OFF-pulses is positioned between two respective ON-pulses of the ON-pulses.

17. The device of claim 10, wherein to activate the second receiver, the first receiver is configured to activate the second receiver from an inactive mode.

18. The device of claim 10, wherein to activate the second receiver, the first receiver is configured to:
output, by the first receiver, an activation signal on a first conductive path that communicatively couples the first and second receivers.

19. A method comprising:
generating, by a first device, a wake-up message; and
transmitting, by the first device, the wake-up message to a second device, and wherein generating the wake-up message includes:
encoding an address associated with the second device into a plurality of packets, wherein the length of each packet of the plurality of packets in combination is representative of the address, wherein at least two packets of the plurality of packets vary in packet length by a multiple of a packet length variance value, and wherein the wake-up message includes the plurality of packets.

20. The method of claim 19, wherein generating the wake-up message includes generating the wake-up message in response to a trigger event.

21. The method of claim 20, further comprising:
determining, by the first device, that data is available for transmission to the second device, wherein the trigger event is based on the determination that data is available for transmission to the second device.

22. The method of claim 19, wherein the address is a plurality of bits.

23. The method of claim 22, wherein each respective packet length of the plurality of packets corresponds to N bits of the plurality of bits, where N is an integer greater than or equal to 2.

24. The method of claim 23, wherein each respective packet length is greater than the N bits to which the respective packet length corresponds.

25. A device comprising:
at least one antenna;
a transmitter communicatively coupled to the at least one antenna; and
at least one processing unit communicatively coupled to the transmitter, wherein the at least one processing unit is configured to generate a wake-up message, wherein the transmitter is configured to transmit the wake-up message to a second device using the at least one antenna, and wherein to generate the wake-up message, the at least one processing unit is configured to:
encode an address associated with the second device into a plurality of packets, wherein the length of each packet of the plurality of packets in combination is representative of the address, wherein at least two packets of the plurality of packets vary in packet length by a multiple of a packet length variance value, and wherein the wake-up message includes the plurality of packets.

26. The device of claim 25, wherein to generate the wake-up message, the at least one processing unit is configured to generate the wake-up message in response to a trigger event.

27. The device of claim 26, wherein the at least one processing unit is further configured to:
determine that data is available for transmission to the second device, wherein the trigger event is based on the determination that data is available for transmission to the second device.

28. The device of claim 25, wherein the address is a plurality of bits, and wherein each respective packet length of the plurality of packets corresponds to N bits of the plurality of bits, where N is an integer greater than or equal to 2.

29. The device of claim 28, wherein each respective packet length is greater than the N bits to which the respective packet length corresponds.

30. The device of claim 25, wherein the device is a non-mobile device or a mobile device, wherein the non-mobile devices includes a base station.
